(19) United States
(12) Patent Application Publication
(10) Pub. No.: US 2024/0370754 A1
(43) Pub. Date: Nov. 7, 2024

(54) QUANTUM DATA CENTER

(71) Applicant: THE UNIVERSITY OF CHICAGO, CHICAGO, IL (US)

(72) Inventors: Liang JIANG, Chicago, IL (US); Connor HANN, NEW HAVEN, CT (US); Junyu LIU, Pasadena, CA (US)

(21) Appl. No.: 18/684,935

(22) PCT Filed: Aug. 19, 2022
(86) PCT No.: PCT/US2022/040951

§ 371 Date: Feb. 20, 2024

Related U.S. Application Data
(60) Provisional application No. 63/235,275, filed on Aug. 20, 2021.

(51) Int. Cl. G06N 10/20; G06F 16/22; G06F 16/245; G06N 10/40

(52) U.S. Cl. CPC G06N 10/20; G06F 16/22; G06F 16/245; G06N 10/40

(57) ABSTRACT

A quantum data center includes a quantum computer and a transceiver. The transceiver is in communication with the quantum computer and is operable to communicate with a remote user via a quantum communication network. The quantum computer (i) receives, via the transceiver, a quantum input state from the remote user, (ii) stores, in a quantum random access memory, a plurality of database states in a plurality of database qudits forming a database register, (iii) queries the quantum random access memory with the quantum input state to retrieve, from the database register, a quantum output state that is based on one or more of the plurality of database states, the quantum output state being disentangled from the quantum input state and the plurality of database states, and (iv) transmits, via the transceiver, the quantum output state to the remote user.

### RELATED APPLICATIONS

This application claims priority to U.S. Provisional Patent Application No. 63/235,275, filed on Aug. 20, 2021, the entirety of which is incorporated herein by reference.

### STATEMENT REGARDING FEDERALLY SPONSORED RESEARCH OR DEVELOPMENT

This invention was made with government support under grant numbers W911NF-18-1-0020, W911NF-18-1-0212, and W911NF-16-1-0349 awarded by the Office, Army Research grant numbers EFMA1640959, OMA1936118, and EEC1941583 awarded by the National Science Foundation, and grant numbers FA9550-19-1-0399 and FA9550-21-1-0209 awarded by the Air Force Office of Scientific Research. The government has certain rights in the invention.

### BACKGROUND

Quantum information science is currently a rapidly developing and highly valued research area with wide applications in computation [1-4], data science and machine learning [5-6], communication [7-13], and sensing [14-16]. Quantum computation may bring significant advantages to some specific algorithms. Quantum communication will strictly guarantee data security and privacy, boost transmission efficiency based on the laws of physics. Quantum sensing may boost the measurement precision significantly.

However, the application of quantum information science in the real world may generate large amounts of data. Quantum data (in qubits) will carry the information, so we need some special units to handle quantum data as well as efficient methods to make the quantum data interact with the classical world. At the same time, the scale of classical data is getting bigger and bigger, and one could naturally consider storing and processing classical data in quantum devices with large Hilbert space dimensions. The generation, processing, and application of quantum data, and the treatment of those data together with their classical counterparts, are currently challenging theoretical and experimental problems in quantum science.

### SUMMARY

Embodiments herein include a quantum data center (QDC), an architecture combining quantum random access memory (QRAM) and quantum networks. Potential applications of disclosed architectures include quantum computation, quantum communication, and quantum sensing, with a primary focus on QDC for T-gate resources, QDC for multi-party private quantum communication, and QDC for distributed sensing through data compression. The QDC provides efficient, private, and fast services as a future version of data centers.

In a first aspect, a quantum data center includes a quantum computer and a transceiver. The transceiver is in communication with the quantum computer and is operable to communicate with a remote user via a quantum communication network. The quantum computer (i) receives, via the transceiver, a quantum input state from the remote user, (ii) stores, in a quantum random access memory, a plurality of database states in a plurality of database qudits forming a database register, (iii) queries the quantum random access memory with the quantum input state to retrieve, from the database register, a quantum output state that is based on one or more of the plurality of database states, the quantum output state being disentangled from the quantum input state and the plurality of database states, and (iv) transmits, via the transceiver, the quantum output state to the remote user.

In a second aspect, a method for a quantum data center includes (i) receiving, via the transceiver of the quantum data center, a quantum input state from a remote user, (ii) storing a plurality of database states in a plurality of database qudits forming a database register, (iii) implementing, with the quantum computer of the quantum data center, a quantum random access memory with the database register, (iv) querying, with the quantum computer, the quantum random access memory with the quantum input state to retrieve, from the database register, a quantum output state that is based one or more of the plurality of database states, the quantum output state being disentangled from the quantum input state and the plurality of database states, and (v) transmitting, via the transceiver, the quantum output state to the remote user.

In a third aspect, a method for a quantum data center includes (i) sending, via a quantum communication network, a quantum input state to the quantum data center, and (ii) receiving, via the quantum communication network, a quantum output state from the quantum data center.

### BRIEF DESCRIPTION OF THE FIGURES

FIG. 1 illustrates a quantum data center, in embodiments.

FIG. 2 illustrates a minimal quantum data center, in an embodiment.

FIG. 3 is a plot of a relative time costs over size of data N of quantum data centers of FIG. 2.

FIG. 4 illustrates a multi-party private quantum communication protocol, in an embodiment.

FIG. 5 illustrates a quantum data center for quantum sensing, in an embodiment.

FIG. 6 illustrates a quantum data center that incorporates a quantum cloud computing into the minimal quantum data center of FIG. 2.

FIG. 7 illustrates an example of a quantum data center serving as an oracle.

FIG. 8 is a plot illustrating a dependence of the total error on the physical error rate.

FIG. 9 shows plots that illustrate the savings associated using an embodiment of the quantum data center of FIG. 1.

FIG. 10 illustrates an example usage of a compression scheme in a quantum random access memory.

### DETAILED DESCRIPTION

### 1. Introduction

A quantum data center (QDC) is a unified concept referring to some specific quantum hardware that could efficiently deal with the quantum data and provides an efficient interface between classical data and quantum processors. The key component of a QDC is a quantum random access memory (QRAM) [17-25], which is a device that allows a user to access multiple different elements in superposition from a database (which can be either classical or quantum). At a minimum, a QDC includes a QRAM coupled to a quantum network.

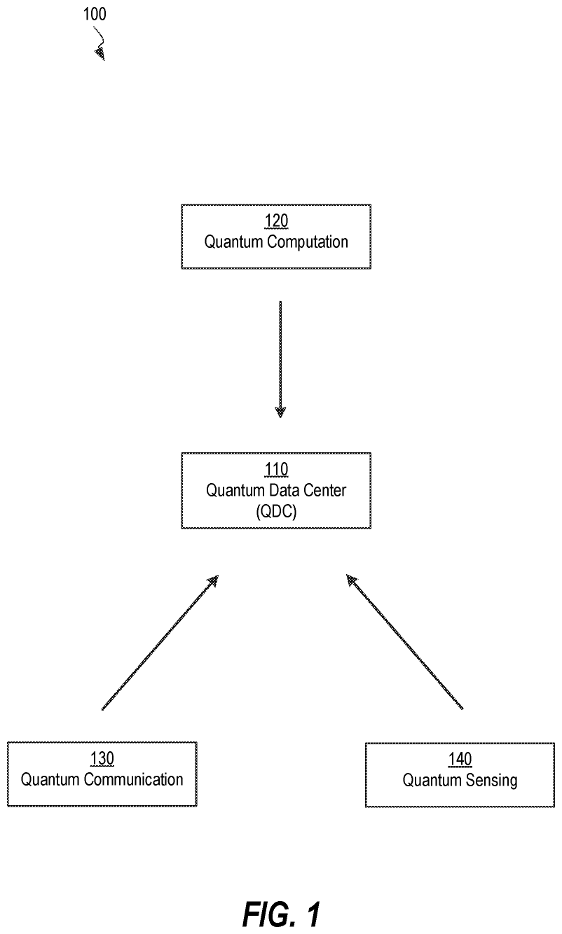

FIG. 1 illustrates a QDC 110. QDC 110 may provide services that include quantum computation 120, quantum communication 130, and quantum sensing 140. QDC 110 may include an implementation of data-lookup oracles in fault-tolerant quantum computations 120. QDC 110 may be mediators of so-called multi-party private quantum communications 130, which combines the quantum private query (QPQ) and quantum secret sharing protocols as described below. QDC 110 may also provide quantum data compressors for distributed sensing applications.

To provide the services above, QDC 110 may include a quantum computer and a transceiver. The transceiver, in communication with the quantum computer, may communicate with a remote user via a quantum communication network. The quantum computer may operate to (i) receive, via the transceiver, a quantum input state from the remote user, (ii) store, in a QRAM, a plurality of database states in a plurality of database qudits forming a database register, (iii) query the QRAM with the quantum input state to retrieve, from the database register, a quantum output state that is based on one or more of the plurality of database states, the quantum output state being disentangled from the quantum input state and the plurality of database states, and (iv) transmit, via the transceiver, the quantum output state to the remote user.

### 2. General Theory

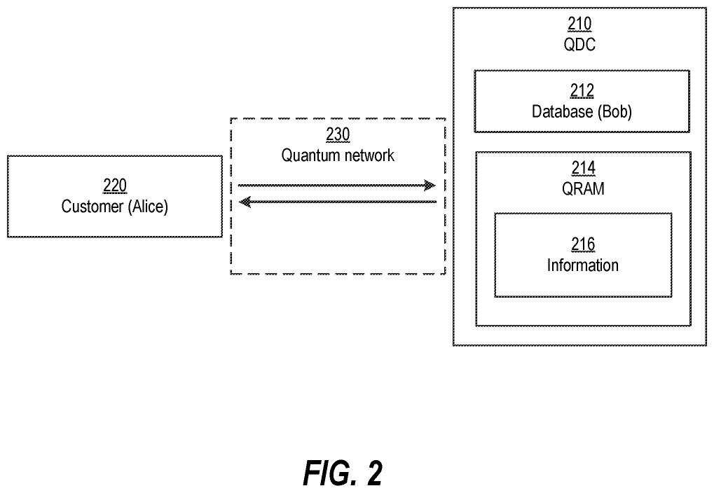

FIG. 2 illustrates a minimal QDC 210, which is an embodiment of QDC 110 of FIG. 1. QDC 210 is a quantum or classical database that includes a QRAM 214 and a database 212. QRAM 214 stores information 216, which may be classical data or quantum data. Hereinafter, the terms Alice or user, used interchangeably, refer to a generic customer of a QDC, and the term Bob refers to a generic database in the QDC. For example, in FIG. 2, Alice (the customer) 220 may upload and download information 216 (classical or quantum) by providing the address to Bob (the database) 212, and Bob 212 provides the information 216 to Alice 220 through QRAM 214, sending it via the quantum network 230.

About the role of QRAM, there are numerous quantum algorithms that claim potential advantages against their classical counterparts, but those algorithms often implicitly require an interface between classical data and the quantum processor. The advantages of the computational complexity are estimated usually from the query complexity where the oracle provides this interface (see, for instance, Ref. [5]). The QRAM (see Refs. [17, 25, 27]) is a general-purpose architecture that could serve as a realization of such oracles. For example, QRAM allows a user to perform a superposition of queries to different elements of a dataset stored in memory. The data itself may be either classical or quantum. In the case where the data is classical, the user provides an arbitrary superposition of addresses as input, and the QRAM returns an entangled state where the addresses are correlated with the corresponding data:

$${{{{{\sum }_{i = 0}^{N - 1} {α}_{i} \vert i 〉}^{{Q}_{1}} \vert 0 〉}^{{Q}_{2}} \to {\sum }_{i = 0}^{N - 1} {α}_{i} \vert i 〉}^{{Q}_{1}} \vert {x}_{i} 〉}^{{Q}_{2}} \qquad ( 1 )$$

Here, the superscripts Q₁ and Q₂ denote respective input and output qubit registers, xᵢ denotes the i^{th} element of the classical dataset, aᵢ are generic coefficients, and N is the size of the database. We emphasize the distinction between QRAM, defined in Eqn. 1, and so-called random-access quantum memories, where the latter do not allow for accessing a superposition of multiple different data elements and hence are not sufficient for our purposes. Indeed, the ability to perform a superposition of queries as in Eqn. 1 is important to the applications we describe below.

Alternatively, the QRAM may store quantum data. In this case, the user provides an arbitrary superposition of addresses as input, but the QRAM returns the quantum state that was stored in the memory location specified by the address. More precisely, if the QRAM holds an arbitrary product state, ⊗ⱼ₌₁^{N}|ψⱼ [symbol] ^{D}^{ⱼ}, where Dⱼ denotes the j^{th} cell of the memory, then a QRAM query enacts the operation

$${{{{{{{\sum }_{i = 0}^{N - 1} {α}_{i} \vert i 〉}^{{Q}_{1}} \vert 0 〉}^{{Q}_{2}} [ {⊗}_{j = 1}^{N} \vert {ψ}_{j} 〉}^{{D}_{j}} ] \to {\sum }_{i = 0}^{N - 1} {α}_{i} \vert i 〉}^{{Q}_{1}} \vert {ψ}_{i} 〉}^{{Q}_{2}} [ {⊗}_{j = 1}^{N} \vert {\overline{ψ}}_{j}^{( i )} 〉}^{{D}_{j}} ] , \qquad ( 2 )$$

which, conditioned on register Q₁ being in state |i [symbol] , swaps the state of register Q₂ and the i^{th} cell of the quantum memory. Here, |ψ̅ⱼ⁽ⁱ⁾ [symbol] =|0 [symbol] for i=j, and |ψ̅ⱼ⁽ⁱ⁾ [symbol] =|ψⱼ [symbol] otherwise. By linearity, this also defines the query operation when the QRAM holds an entangled state. Note that, when the data is quantum, a QRAM query may leave the Q₁ and Q₂ registers entangled with the data. The difference between the classical and quantum operations will be evident when we try to “write” the data in QDSs, as described in Section 3 below.

As a formal definition, a QDC denoted [symbol] ={ [symbol] , [symbol] } includes a QRAM [symbol] coupled to a quantum communication network [symbol] . A query to the QDC may be performed in three steps: (i) a remote user uses [symbol] to send a quantum query to the QDC, (ii) the QDC executes query using [symbol] , as in either Eqns. 1 or 2, and (iii) the QDC uses [symbol] to send input and output qubit registers, Q₁ and Q₂, back to the user. [symbol] is characterized by four parameters: the size of the database N, the error in the query ϵ, the latency τ (time cost of a single query), and the throughput T (number of queries performed per unit time).

QRAM requires that different elements of the memory can be queried in superposition as in Eqns. 1 and 2. Moreover, there are extended parameters we could choose when we choose the circuit depth or the width of the QRAM implementation, see Refs. [22, 24, 25, 31-34], but for latter applications, we assume our QRAM circuits to be shallow. Further, we assume that QRAM has been built in the fault-tolerant way and has been error-corrected. Building a large-scale fault-tolerant QRAM is, in fact, a primary challenge in experiments.

Quantum networks may be realizable in the future due to the fast development of quantum communication technology in recent years. Here, we are considering the service provided by QDC is centralized and has some physical distances from users. Thus, quantum states are supposed to be teleported through the quantum network from the user to the QDC or vice versa, where quantum teleportation technology includes the technologies of quantum satellites [35-37] and quantum repeaters [10, 12, 13, 38-40].

### 2.1 QDC for Quantum Computing

In an example of a QDC applied for quantum computing, we show how a QDC may provide resource savings in a fault-tolerant cost model to users running query-based quantum algorithms. There are two aspects of resource savings induced by QDC: (i) hardware outsourcing and (ii) communication costs (see Section 3 below for a unification of space and time costs). The reason for the hardware outsourcing is simple. Imagine that we are doing fault-tolerant quantum computation with a significant amount of T-gates in the queries, which may be expensive and require the magic state distillation [41, 42]. Rather than preparing the requisite magic states themselves, the user could instead ask the QDC to prepare the magic states, thereby reducing the resources required of the user. This naive approach, however, has a high communication cost since each magic state would need to be sent over the quantum network from the QDC to the user.

In contrast to this naive approach, we propose that the user outsources entire oracle queries to the QDC. Outsourcing entire queries provides a particularly efficient way for users to offload large amounts of magic state distillation to the QDC with minimal communication cost. More specifically, without the aid of a QDC, a user would be required to distill at least [symbol] (\sqrt{N}) [32] magic states to query a data set of size N as in equation (1). In contrast, with a QDC, a user can outsource the query to the QDC: the QDC is responsible for implementing the query and distilling the associated magic states, while the user only incurs a [symbol] (log N) communication cost. This communication cost is due to the fact that the input and outputs of the query must be sent between the user and the QDC. The user also benefits in that they are no longer responsible for the potentially large amount of ancillary qubits needed to implement a query [22, 32, 33]; this hardware cost is paid by the QDC.

We emphasize that this approach of outsourcing full queries to the QDC is exponentially more efficient than naive the approach described previously in terms of communication cost. The native approach would incur a prohibitive [symbol] (\sqrt{N}) communication cost per query. In contrast, by outsourcing entire queries to the QDC, one effectively funnels a large amount of “magic” (the [symbol] (\sqrt{N}) magic states required to implement a query) into a very small number of transmitted qubits (the [symbol] (log N) qubits comprising the query's output). This way, the user receives maximal assistance from the QDC at minimal communication cost.

Both the savings from the hardware and the communication costs could be quantifies this benefit by the following example. Suppose a user wishes to run a 100-qubit algorithm that requires 10⁸ T-gates when decomposed into Clifford+T operations. Further, suppose that the user has a device with physical error rates of p=10⁻³ and that the target failure probability for the entire computation is <1%. To achieve this failure probability, we assume error correction is used, and that gates are implemented fault tolerantly. Non-Clifford gates are implemented fault-tolerantly with the aid of magic state distillation.

A resource estimate for exactly this situation is performed in Ref. [43] for surface codes (see Section 3 below). The outsourcing can enable resource savings for the user (potentially both in the overall algorithm runtime and hardware cost). To estimate these savings, we suppose that these queries are responsible for 99% of the algorithm's T-state consumption (this is not an unreasonable supposition; see, for instance, Ref. [33]). According to Ref. [43] and Section 3 below, we observe that the user can now use a 15-to-1 magic state distillation scheme, as the user need only produce ˜10⁶ magic states, and the total probability that any such state is faulty is 10⁶×35p³˜0.01, which is within the allowed error tolerance. As described in Ref. [43], the number of surface code tiles required for computation and distillation with the 15-to-1 scheme is 164. With the distillation scheme selected, we can now estimate the required code distance d and algorithm run time. The code distance must satisfy,

$$( \#tiles = 164 ) \times ( \#code cycles \times ( 1 + delay ) ) \times {p}_{L} ( p , d ) < 1 \% , \qquad ( 3 )$$

to guarantee that that the total error probability remains below 1%. Here p_{L} is the logical error probability of a distance d surface code with physical error probability p, which is approximately given by Ref. [44]. The parameter #code cycles is the number of surface code cycles required to distill 10⁶ magic states, i.e., the minimum number of cycles required to run the algorithm assuming instantaneous data center queries. In practice, however, the data center queries will not be instantaneous. Thus, we add a delay factor to the total number of cycles. This delay is related to the QDC's latency τ, and the exact amount of the delay depends not only on how the oracle is implemented by the QDC but also on the communication time overhead. Moreover, with the \sqrt{N}→log N arguments from the communication cost, we could (use assumptions, delay factor ˜ [symbol] (\sqrt{N}) or delay factor 18 [symbol] (log N), respectively, referring to the protocols where oracle queries are implemented by the user (with magic states sent one-by-one from the QDC) or where full queries are implemented by the QDC.

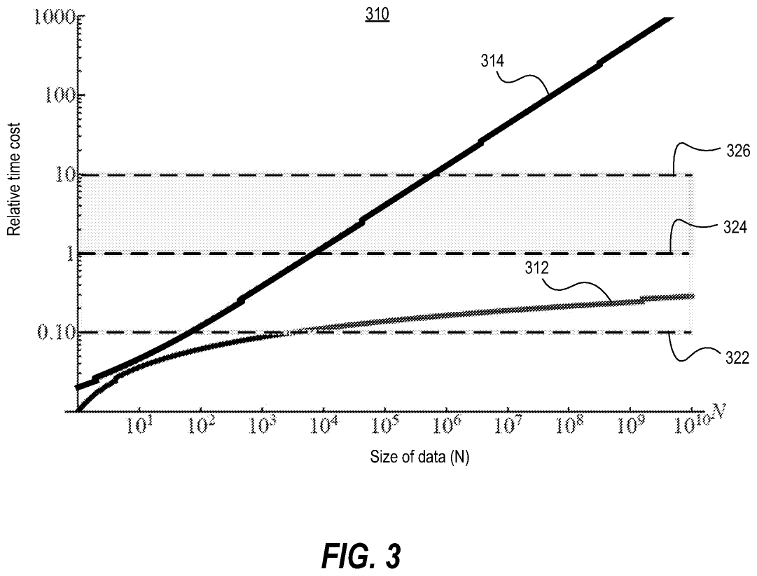

FIG. 3 is a plot 310 of the relative time costs over size of data N of QDCs. The relative time cost is the time cost from the user side with QDCs, divided by the one without QDCs. Plot 310 denotes thresholds 322, 324, and 326, which indicate where QDC has the comparable performance as the situation without QDC, with the relative ratios of 0:1, 1 and 10. Different thresholds correspond to pre-factors relating the delay factor and the data N, and the relative ratio choices might correspond to different physical hardware. The plot 310 includes traces 312 and 314. The trace 314 represents the relative time costs for a naïve usage of QDCs, while the trace 312 represents the relative time costs for a smart usage of QDCs. We consider the situations where two different methods of usages of QDCs, and both of them prepare the magic state distillation in the QDC side. We replace the delay factor by the function \sqrt{N} or log N directly where N is the size of the data in those two methods. Some sudden jumps in the traces 312 and 314 are because of the even integer values of the code distance. QDCs provide significant time savings in some ranges of data sizes, where the communication cost savings could be exponential. Finally, although our calculation is query-based, there are proposals where a query-based approach may provide a unified framework for all quantum algorithms [45].

### 2.2 QDC for Quantum Communication

Quantum private query (QPQ) [26], a protocol combining QRAM and quantum networks, could already serve as an important application of QDC for quantum communication. Furthermore, the application of QDCs could be much broader to provide the users with fast and secure service. Based on QPQ and Quantum Secret Sharing from Refs. [8, 9], we propose an original protocol, so-called multi-party private quantum communication, as an example of applications of QDCs. We provide discussions of QPQ and related concepts in Section 3 below.

Private quantum communication refers to the possibility of transmitting quantum information without revealing this information to eavesdroppers. If multiple parties are communicating over a quantum network, eavesdroppers may nevertheless be able to learn who has sent information and who has received it, even if they cannot determine what that information was. Multi-party private quantum communication refers to a stronger notion, where eavesdroppers can neither learn what information was communicated nor which users were communicating to which others. To our knowledge, this notion of multi party private quantum communication and the corresponding protocol is introduced for the first time in our paper.

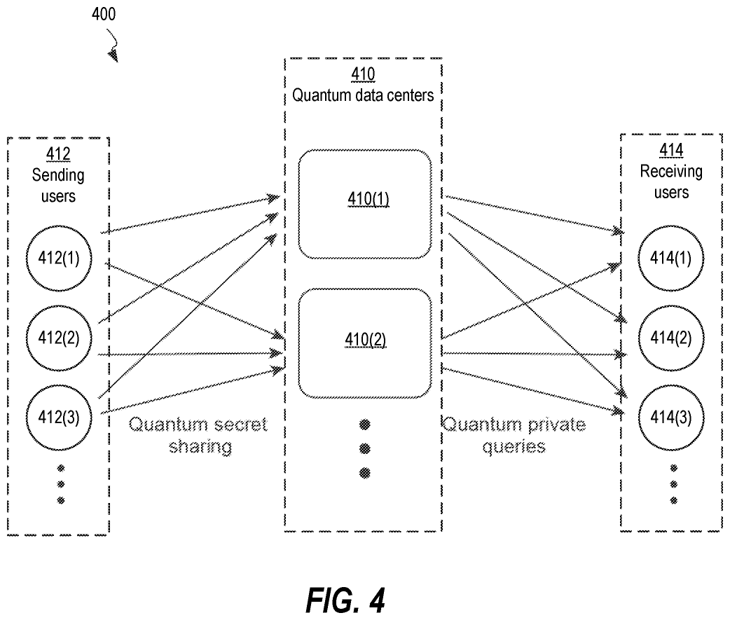

FIG. 4 illustrates a multi-party private quantum communication protocol 400 (protocol 400 hereinafter) that includes a plurality of QDCs 410. The protocol 400 includes sending users 412, receiving users 414, and QDCs 410. QDCs 410 includes one or more QDC(k), where k is a positive integer. In an example usage, one or more sending users 412 may wish to communicate privately to one or more receiving users 414. In general, sending user 412(i) communicates with one or more of receiving user 414(j), where i and j are both positive integers and are not generally equal. The communication occurs through two or more untrusted (but non-cooperating) QDCs 410. Importantly, it is assumed that the users 412 and 414 do not share any initial secret keys or entangled qubits, and that the users 412 and 414 do not possess any secure communication links between them (either classical or quantum). All communication takes place over the untrusted quantum network shared with the QDCs 410.

In a use scenario of the protocol 400, each sending user 412(i) first takes his or her quantum message and decomposes it into several distinct parts using a quantum secret sharing protocol, such as described in Refs. [8, 9]. In isolation, each part of the secret message looks like a maximally mixed state, but when sufficiently many parts are assembled together, the original message can be perfectly recovered. Second, each sending user 412(i) sends parts of their secrets to the QDCs 410, where they are stored in QRAM at a publicly announced address. No one QDC(k) should receive enough parts of a secret to reconstruct the original message. Finally, the receiving users 414 interrogate the QDCs 410 using the quantum private queries protocol. Each receiving user 414(j) interrogates sufficiently many QDCs 410 to retrieve enough parts of the secret to reconstruct the original message from the sending user 412(i).

The protocol 400 constitutes a private multi-party quantum communication because (i) the use of secret sharing means that no QDC may learn what information is being communicated, and (ii) the use of Quantum Private Queries means that no QDC can learn which receiving user 414(j) is accessing the information transmitted by sending user 412(i). A crucial assumption in the protocol 400 is that the QDCs 410 are non-cooperating. If the QDCs 410 cooperate, they could work together to reconstruct the secret. To mitigate this problem, each secret may be divided into an increased number of parts (along with the increased number of QDCs 410). This way, revealing the secret would require cooperation between an increasingly large number of QDCs.

Note that our approach is different from the so-called covert quantum communication [47]. Covert quantum communication refers to a stronger notion, where eavesdroppers cannot even detect whether any information has been transmitted in the first place. In the protocol of Ref. [47], Alice and Bob are assumed to share a random, secret key, and the quantum information is sent via optical photons from Alice to Bob at one of N times specified by the key. The probability that an eavesdropper can distinguish between this situation and that where no information is communicated at all (i.e., when no photons are sent) is shown to decrease as 1/\sqrt{N}. In the limit of large N, the eavesdropper cannot determine whether any information has been sent.

Note that the multi-party private quantum communication scheme is teleporting quantum states, not classical information. Those quantum states are naturally merged with quantum private queries where the security is guaranteed quantumly, making the usage of superposition of addresses in QRAM. Moreover, an important technicality regarding the last step of the protocol is that the QDCs store quantum data, and, in general, the act of accessing this data can perturb the quantum database (a consequence of the no-cloning theorem). The QDC may, in principle, detect this perturbation, and use this information to infer which receiving user 414(j) is accessing the information transmitted by sending user 412(i). To prevent this, we suppose that the quantum data is accessed as follows. In addition to sending a state |i [symbol] specifying which element to access, each receiving user 414(j) also sends a quantum state ρⱼ to the QDC 410. The QDC 410 then swaps ρⱼ with the state stored at location i in the memory. If ρⱼ is chosen to be a maximally mixed state, this data access procedure has no backreaction on the database; from the perspective of each QDC, the states stored in the database always look maximally mixed.

### 2.3 QDC for Quantum Sensing

In the context of quantum sensing, QDCs can be used to compress quantum data and signals, enabling more efficient communication in distributed sensing tasks. We discuss this application in further detail below, but we begin by first describing the underlying capability that enables these applications—the ability of a QDC to compress quantum data.

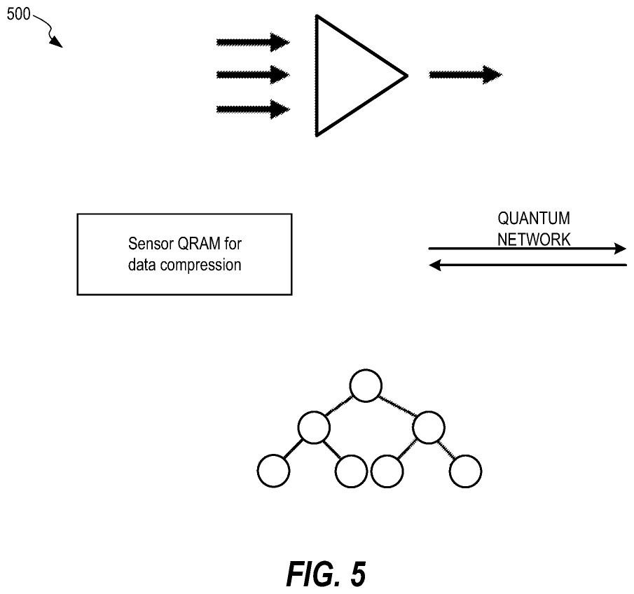

FIG. 5 illustrates a QDC 500 for quantum sensing. QDC 500, which is an embodiment of QDC 110 of FIG. 1, performs quantum data compression to enable distributive sensing. The reason for compressing the data during quantum sensing, is that the raw data has low entanglement entropy. Thus, it is resource-consuming to teleport such low entropy data directly. Hence we need quantum data compression to build more efficient distributed quantum sensors.

We illustrate how QDCs can be used to compress quantum data through a simple example. Suppose that the quantum data held by the QDC is confined to the single-expectation subspace, spanned by states where only one of the N qubits in the QDC's quantum memory is in the |1 [symbol] state and all others are in |0 [symbol] . The state of the memory can then be written as

$${\vert {ψ}_{unary} 〉 = {\sum }_{i = 0}^{N - 1} {α}_{i} {⊗}_{j = 1}^{N} \vert {δ}_{ij} 〉}^{{D}_{j}} , \qquad ( 4 )$$

where Dⱼ indicates the j^{th} qubit in the N-qubit quantum memory, and δᵢⱼ is the Kronecker delta (δᵢⱼ=1 for i=j and δᵢⱼ=0 otherwise). Though the entire Hilbert space of the N-qubit quantum memory has the dimension 2^{N}, the single-excitation subspace has only dimension N. Thus, one could equivalently represent the above state using only log N qubits, as

$${\vert {ψ}_{binary} 〉 = {\sum }_{i = 0}^{N - 1} {α}_{i} \vert i 〉}^{{Q}_{1}} , \qquad ( 5 )$$

where Q₁ denotes a log N-qubit register, and |i [symbol] ^{Q}^{₁} denotes the i^{th} basis state of this register. The two states |ψ_{unary} [symbol] and |ψ_{both} [symbol] contain the same quantum information (the N complex coefficients αᵢ) but encode this information in different ways. The mapping |ψu_{nary} [symbol] →|ψ_{binary} [symbol] constitutes compression of this quantum information because the information is mapped from an N-qubit encoding to a log N-qubit encoding. The compressed state |ψ_{binary} [symbol] can be more efficiently stored or transmitted.

A QDC can be used to realize the unary-to-binary compression described above. The compression proceeds in two steps: first, the QDC performs an operation U (defined below) that encodes the location of the single excitation into a log N-qubit address register, then a single QRAM query is performed in order to extract the excitation from the memory. In detail, the unitary U enacts the operation,

$${{{{U ( \vert 0 〉}^{{Q}_{1}} {\sum }_{i = 0}^{N - 1} {α}_{i} [ {⊗}_{j = 1}^{N} \vert {δ}_{ij} 〉}^{{D}_{j}} ] ) = {\sum }_{i = 0}^{N - 1} {α}_{i} \vert i 〉}^{{Q}_{1}} [ {⊗}_{j = 1}^{N} \vert {δ}_{ij} 〉}^{{D}_{j}} ] . \qquad ( 6 )$$

We note that the operation U is not equivalent to a QRAM query (see Eqn 2), so U falls outside the scope of operations that a QDC can perform per the minimal definition. As we describe below, however, the operation U can be straightforwardly implemented using only minor modifications to standard QRAM architectures. Next, a QRAM query extracts the single excitation from the quantum memory and stores it in an output register Q₂,

$${{{{{{\sum }_{i = 0}^{N - 1} {α}_{i} \vert i 〉}^{{Q}_{1}} \vert 0 〉}^{{Q}_{2}} [ {⊗}_{j = 1}^{N} \vert {δ}_{ij} 〉}^{{D}_{j}} ] \to {{\sum }_{i = 0}^{N - 1} {α}_{i} \vert i 〉}^{{Q}_{1}} \vert 1 〉}^{{Q}_{2}} [ {⊗}_{j = 1}^{N} \vert 0 〉}^{{D}_{j}} ] . \qquad ( 7 )$$

After this step, the Q₂ and Dⱼ registers are disentangled from the Q₁ register. The state of the Q₁ register is |ψbinary [symbol] , which constitutes the compressed representation of the quantum data that was originally stored in the QDC's memory. This compressed data may subsequently be stored, transmitted, or measured, depending on the application [48]. Thus, QDCs can be used to reduce the entanglement cost for distributed sensing applications.

Suppose that two or more physically separated users probe some system, such that a quantity of interest is encoded in an entangled state shared between them. If local operations do not suffice to measure this quantity, then quantum information must be transmitted between the users. If each user has N qubits of quantum data, then N entangled pairs will be required to transmit the information in general. In certain situations, this entanglement cost can be greatly reduced using a QDC. For example, if the N-qubit states are guaranteed to lie in the single-excitation subspace, then they can be transmitted using only log N entangled pairs using the unary-to-binary compression described above. This is the case for quantum-assisted telescope arrays [49], where quantum networks are used to enable optical interferometry. In this context, a single optical photon arrives at one of multiple telescopes in superposition, with its arrival time and frequency unknown. Supposing that the photon arrives at one of N unknown time-frequency bins, Refs. [50, 51] show that unary-to-binary compression enables the optical phase difference to be extracted using only log N entangled pairs. QDCs could be directly used to implement this compression. In fact, using a QDC to implement the compression is more hardware efficient than the approach proposed in Ref. [51]. In that work, the authors consider the case where a photon arrives at one of T_{bin} different time bins and in one of R different frequency bands, and they describe a procedure that uses [symbol] (R log T_{bin}) qubits to compresses the photon's arrival time and frequency information.

The same compression can be achieved with a QDC using only [symbol] (R)+ [symbol] (log T_{bin}) qubits as follows. At each time step, any incoming photon is stored in one of R different memory qubits according to its frequency band. These R qubits constitute the QDC's quantum memory, and the QDC performs unary-to-binary compression scheme described above to compress this which-frequency information. If the photon arrived at the present time step, it is now stored at a definite location (namely, register Q₂ in equation (7)). The presence of this photon can then be used to control the binary encoding of the which-time information, as in Ref. [50]. Altogether, this procedure requires [symbol] (R) qubits for the QDC and its quantum memory, plus an additional [symbol] (log T_{bin}) qubits to hold the compressed which-time information, hence the total hardware cost is [symbol] (R)+ [symbol] (log T_{bin}) qubits. When counting the communication time cost, the savings will be more drastic. More sophisticated compression protocols can enable further reduction in entanglement cost. If each mode of an M-mode system is populated with a photon with probability p, then the quantum data can be transmitted as few as MH(p) qubits, where H(p) is the binary entropy, using a scheme for Schumacher coding [52]. Such schemes would further reduce the entanglement cost. Moreover, a QDC equipped with quantum sorting networks (a generalization of QRAM), can implement Schumacher coding in polylogarithmic time [53], enabling improved detector bandwidth.

### 3. Quantum Data Center: Theories and Applications

This section provides some necessary information and related results about QDCs. In Section 3.1, several basic aspects of QDC are described, and more specifically, some perspectives on the writing function of QDCs. In Sections 3.2, 3.3 and 3.4, examples of QDC usage when applied in quantum computation, quantum communication, and quantum sensing, respectively, are presented.

### 3.1 Basic Aspects of a QDC

### 3.1.A General Discussion

Here we comment on some general perspectives about QDCs. We note also that some architectures without either QRAM or quantum networks could still be defined as QDCs. In Section 3.4, we describe an application in quantum sensing where QRAMs are not necessarily used, but one could still use QDC architectures to realize it.

QDCs are different from a generalized version of quantum computers. A universal quantum computing (UQC) device that is associated with QDC may be developed. However, it is not necessary, and the QDC construction may directly serve remote users with their own quantum computation architectures. In fact, some of our examples mentioned later do not require UQC power for QDC, for instance, QDCs for the T-gate counting that have been discussed in the main text. Moreover, QDCs may, in addition to the above minimal definition, function in a generalized form. For example; QDCs equipped with UQC may also perform quantum cloud computation.

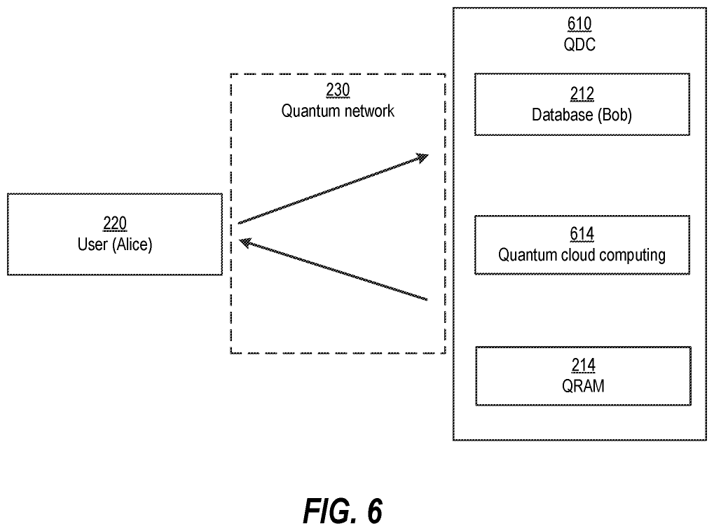

FIG. 6 illustrates a QDC 610 that incorporates a quantum cloud computing 614 into a minimal QDC 210 of FIG. 2. As quantum computers are still emerging, it may be easier to consider remote cloud services running in QDCs while providing results of computations to remote users. Additionally for privacy, quantum blind computation [57,58] may be performed in QDCs with the help of quantum networks [58].

While the QDC disclosed herein may seem closely related to the idea of disposable quantum software proposed in Ref. [59], the quantum software, as defined in Ref. [59], is a fragile quantum state that is difficult to maintain by users and is, therefore, preferably bought through the quantum network. An early quantum teleportation scheme based on Ref. [60] provides significant power for quantum devices by combining UQC and quantum communication, inspiring the observation in Ref. [59] for quantum software. Therefore, the embodiments of QDC described herein feature ingredients from QRAM that enable extra capabilities for computation, communication, and sensing.

### 3.1.B Cost Estimation for QDCs

For QDCs defined above, we estimate the cost of time, hardware with a given requirement of error and privacy. Here we establish a general theory to estimate the hardware-time cost for QDCs and determine optimal parameters according to the cost function.

In general, we define a cost function F_{cost}^{QDC} for a given QDC architecture. The cost function may be written as

$${F}_{cost}^{QDC} = {F}_{cost}^{QDC} ( {T}_{total} , {N}_{total} , {P}_{total} ) . \qquad ( 8 )$$

Here, the cost function F_{cost}^{QDC} includes a time cost T_{cost}, space (hardware) cost N_{cost}, and a privacy cost Pₜₒₜₐₗ, where the privacy cost refers a quantity that represents a level of consumption for the QDC users. In an example, the above cost function may be linear in terms of each cost:

$${F}_{cost}^{QDC} = {α}_{T} {T}_{total} + {a}_{N} {N}_{total} + {α}_{P} {P}_{total} , \qquad ( 9 )$$

with fixed positive coefficients α_{T}, α_{N} and α_{P}. In general, F_{cost}^{QDC} may be defined as a monotonic function of T_{cost}, N_{cost} and Pₜₒₜₐₗ. Moreover, T_{cost}, N_{cost} and Pₜₒₜₐₗ are given by one collection of throughput parameters, and the other collection of hyperparameters (latency) θ. The optimal hyperparameters may be determined by

$${θ}^{*} = arg {min}_{θ} {F}_{cost}^{QDC} . \qquad ( 10 )$$

for given requirements of hardware.

For comparison, a similar analysis may be carried out for their counterparts without involving a QDC, with a cost function F_{cost}^{Q̅D̅C̅}. For example, for a QDC architecture having an advantage over its counterpart, Q̅D̅C̅, F_{cost}^{Q̅D̅C̅} is greater than F_{cost}^{QDC}. When the hardware cost is a qubit cost, contributions from both Tₜₒₜₐₗ and Nₜₒₜₐₗ are included in the cost. In another example, the entanglement cost may be a form of the hardware cost, as in the T-gate example below. Furthermore, a significant advantage of QDCs will be apparent from the examples below.

### 3.1.0 Writing Data in QRAM

In this section, we more precisely define what it means to write data to QRAM. The definition of writing depends on whether the data being written are (i) classical or (ii) quantum, and also on whether the addressing scheme is (iii) classical or (iv) quantum. We elaborate on these four different situations below.

### 3.1.C1 Classical Data, Classical Addressing

In this situation, the QRAM holds a classical data vector x, and the writing operation consists of specifying a classical address i and a new classical value yᵢ, then overwriting the value i^{th} cell of the QRAM's memory, xᵢ→yᵢ. This writing process is entirely classical; it can be implemented simply by performing classical operations on the classical data.

Even though this definition of writing to QRAM is completely classical, it is still useful in the context of quantum algorithms. In particular, after the writing operation, the modified classical data in the QRAM can subsequently be read in superposition (i.e., with quantum addressing). For example, if each element in the database is replaced as xᵢ→yᵢ, then reading the QRAM consists of the operation

$${{{{{\sum }_{i = 0}^{N - 1} {α}_{i} \vert i 〉}^{{Q}_{1}} \vert 0 〉}^{{Q}_{2}} \to {\sum }_{i = 0}^{N - 1} {α}_{i} \vert i 〉}^{{Q}_{1}} \vert {y}_{i} 〉}^{{Q}_{2}} , \qquad ( 11 )$$

cf. equation (1). Thus, the same QRAM can be re-used to perform a superposition of queries to a different data set. This is particularly useful in the context of QDCs, as multiple users may be running different algorithms that require access to different classical data sets. The QDC may cater to all of these users by overwriting the QRAM's classical data between queries from different users.

### 3.1.C2 Classical Data, Quantum Addressing

In contrast to the previous definition, writing to QRAM for the case of classical data and quantum addressing is not well defined. To illustrate this, we propose a possible definition for writing in this situation, then show that it ultimately reduces to a probabilistic version of the classical writing procedure described above.

When QRAM's classical data is stored in a quantum memory (i.e., each classical datum xᵢ ∈{0,1} is encoded in a qubit as |xᵢ [symbol] ), the full database includes the product state ⊗ᵢ|xᵢ [symbol] ^{D}^{ᵢ}, where Dᵢ denotes the i^{th} cell of the memory. The writing procedure includes (i) specifying a quantum address Σᵢ αᵢ|i [symbol] ^{Q}^{₁}, (ii) coherently conditioned on the state of the Q₁ register, preparing a qubit Q₂ in the state |yᵢ [symbol] where yᵢ∈{0,1}, and (iii) swapping this state with the i^{th} cell of the memory,

$${{{{{{{{\sum }_{i} {α}_{i} \vert i 〉}^{{Q}_{1}} \vert {y}_{i} 〉}^{{Q}_{2}} [ {⊗}_{j = 1}^{N} \vert {x}_{j} 〉}^{{D}_{j}} ] \to {\sum }_{i} {α}_{i} \vert i 〉}^{{Q}_{1}} \vert {x}_{i} 〉}^{{Q}_{2}} [ \vert {y}_{i} 〉}^{{D}_{i}} {⊗}_{j \neq i} \vert {x}_{j} 〉}^{{D}_{j}} ] . \qquad ( 12 )$$

In general, this operation leaves the data registers entangled with the Q₁ and Q₂ registers. As such, tracing out the Q₁ and Q₂ registers leaves the database in a mixed state, wherewith probability |αᵢ|² one finds that i^{th} entry has been overwritten as; xᵢ→yᵢ. To achieve the same result, one may instead have randomly chosen to overwrite the i^{th} element according to the distribution |αᵢ|². Therefore, the combination of quantum addressing and classical data may not be advantageous over using the combination of classical addressing and classical data.

### 3.1.C3 Quantum Data, Classical Addressing

In this situation, the QRAM holds quantum data (i.e., an N-qubit quantum state). The writing operation consists of specifying a classical address i and a new single-qubit state |ϕ [symbol] ^{Q}^{₂}, then swapping this state with the i^{th} qubit in the QRAM's memory. In particular, if the QRAM initially holds a product state ⊗ⱼ|ψj [symbol] ^{D}^{ⱼ}, then this writing procedure enacts the operation

$${{{{{\vert ϕ 〉}^{{Q}_{2}} [ {⊗}_{j} \vert {ψ}_{j} 〉}^{{D}_{j}} ] \to \vert {ψ}_{i} 〉}^{{Q}_{2}} [ \vert ϕ 〉}^{{D}_{i}} {⊗}_{j \neq i} \vert {ψ}_{j} 〉}^{{D}_{j}} ] . \qquad ( 13 )$$

Note that in the case where the quantum data consists of a product state, this operation does not entangle the Q₂ and Dᵢ registers. For general quantum data, however, this operation may leave these registers entangled, such that the data can be left in a mixed state when the Q₂ register is traced out.

### 3.1.C4 Quantum Data, Quantum Addressing

In this situation; the QRAM holds quantum data (i.e., an N-qubit quantum state). The writing operation includes, first, specifying a quantum address Σᵢ αᵢ|i [symbol] . Then; coherently conditioned on the state of the Q₁ register, one prepares another register Q₂ in the state |ϕᵢ [symbol] , then swaps this state with the i^{th} cell of the memory. In the case where the QRAM initially holds a product state ⊗ⱼ|ψⱼ [symbol] ^{D}^{ⱼ}, then this writing procedure enacts the operation

$${{{{{{{{\sum }_{i} {α}_{i} \vert i 〉}^{{Q}_{1}} \vert {ϕ}_{i} 〉}^{{Q}_{2}} [ {⊗}_{j} \vert {ψ}_{j} 〉}^{{D}_{j}} ] \to {\sum }_{i} {α}_{i} \vert i 〉}^{{Q}_{1}} \vert {ψ}_{i} 〉}^{{Q}_{2}} [ \vert {ϕ}_{i} 〉}^{{D}_{i}} {⊗}_{j \neq i} \vert {ψ}_{j} 〉}^{{D}_{j}} ] . \qquad ( 14 )$$

We note that reading quantum data, Eqn. 2 is a special instance of the above process where |ϕᵢ [symbol] =|0 [symbol] for all i. This operation generally leaves the Q₁ and Q₂ registers entangled with the data registers Dᵢ.

### 3.2 Quantum Computation

### 3.2.1 Oracles

One of the most important applications of QDC is quantum computation (e.g., quantum computation 120 of FIG. 1). In the minimal definition of QDCs, we may use the QRAM as a remote service center providing oracles for the user. Many quantum algorithms, such as Quantum Principle Component Analysis, require the construction of oracles to reach the quantum advantage [62]. QRAM may provide substantial a benefit in interfaces between the classical and the quantum worlds, serving as a natural hardware realization of the quantum oracle. Moreover, a hybrid construction of QRAM and quantum read only memory (QROM) may provide an optimal choice of the hardware-time overhead. Thus, the quantum computation may be performed on the user side, and QDCs may serve as the source of the oracle. Connected by quantum networks, the user may call QDCs multiple times to complete the algorithm.

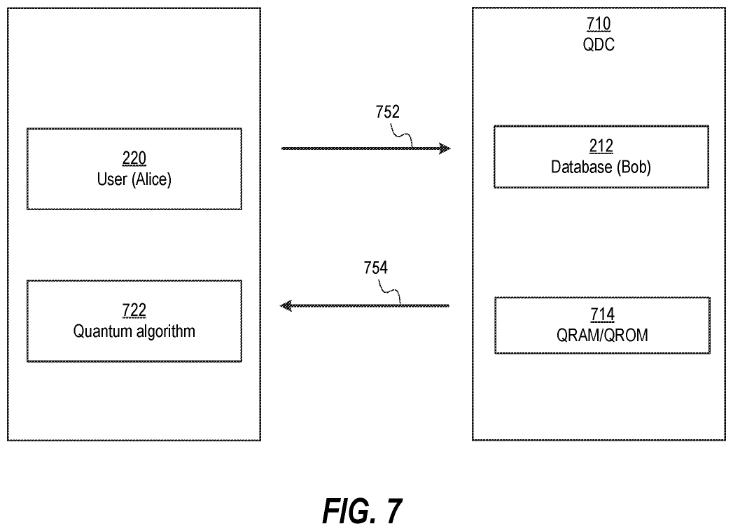

FIG. 7 illustrates an example of QDC 710 serving as a source of oracle. QDC 710 is an example of QDC 210 of FIG. 2 but includes a hybrid QRAM/QROM 714 that may be a source of oracle construction. FIG. 7 shows a quantum algorithm 722 residing in the user side for performing quantum computation. In a use scenario, the user 220 sends a request 752 to the QDC 710, and the QDC 710 provides an oracle 754 to the user 220. The following description below details the hardware-time cost of using QDC as a resource of oracle in a minimal setup.

If we assume that a general quantum algorithm U, such as quantum algorithm 722, has a time cost and a qubit cost given by

$${T}_{U} = {T}_{U} ( L , ϵ , {θ}_{0} , {θ}_{U} ) , \qquad ( 15 )$$

$${N}_{U} = {N}_{U} ( L , ϵ , {θ}_{0} , {θ}_{U} ) .$$

Both costs depend on a problem size L, a precision ∈, collections of other hyperparameters θ_{U}, and problem parameters θ₀. When the time cost of the algorithm itself is expressed by the query complexity, and the corresponding oracle is prepared by QRAM itself multiple times, the QRAM cost may be expressed as:

$${T}_{Q} = {T}_{Q} ( L , ϵ , {θ}_{Q} ) , \qquad ( 16 )$$

$${N}_{Q} = {N}_{Q} ( L , ϵ , {θ}_{Q} ) ,$$

with a QRAM parameter θ_{Q}. Additionally, the quantum network cost may be expressed as:

$${T}_{I} = {T}_{I} ( L , ϵ , {L}_{tot} , {θ}_{I} ) , \qquad ( 17 )$$

$${N}_{I} = {N}_{I} ( L , ε , {L}_{tot} , {θ}_{I} ) .$$

The quantum network cost includes a total length Lₜₒₜ and a quantum network parameter θ_{I}. The oracles may be prepared remotely with the total length Lₜₒₜ, and transferred to the user via quantum network. The total cost then may be expressed as:

$${T}_{total} ( L , ϵ , {L}_{tot} , {θ}_{U} , {θ}_{Q} , {θ}_{I} ) = {T}_{U} ( L , ϵ , {θ}_{U} ) \times ( {T}_{Q} ( L , ϵ , {θ}_{Q} ) + {T}_{I} ( L , ϵ , {L}_{t o t} , {θ}_{I} ) ) , \qquad ( 18 )$$

$${N}_{total} ( L , ϵ , {L}_{t o t} , {θ}_{U} , {θ}_{Q} , {θ}_{I} ) = {N}_{U} ( L , ϵ , {θ}_{U} ) + {N}_{Q} ( L , ϵ , {θ}_{Q} ) + {N}_{I} ( L , ϵ , {L}_{t o t} , {θ}_{I} ) .$$

The time cost includes a query complexity T_{U} for the quantum algorithm U. While the time cost is multiplicative, the qubit cost is additive. Thus, for given L, ∈, and θ₀, an optimal choice of QDC may be determined by

$${( {L}_{tot}^{*} , {θ}_{U}^{*} , {θ}_{Q}^{*} , {θ}_{I}^{*} )}_{L , ϵ , {θ}_{0}} = arg {min}_{{( {L}_{tot} , {θ}_{U} , {θ}_{Q} , {θ}_{I} )}^{{F}_{c o s t}} ,} \qquad ( 19 )$$

$$where$$

$${F}_{c o s t} = {F}_{c o s t} ( {T}_{t o t a l} , {N}_{total} ) . \qquad ( 20 )$$

The cost function F_{cost} is based on the architecture of QDC. This is a specific example of the cost function algorithm equation (8) for quantum computation.

While the quantum algorithm being discussed may be abstract, any quantum algorithms with the oracle required in the QRAM form may be adapted here. In the following section below, we discuss a specific quantum algorithm, quantum signal processing (QSP) for Hamiltonian simulation [54-56], where quantum oracles are needed to address the information of the Hamiltonian. Accordingly, if we use the qubitization algorithm with a number of Pauli terms L appearing in the Hamiltonian, we have

$$\frac{{QDC}_{h a r d ware cost}}{{\overline{QDC}}_{h a r d ware cost}} = \frac{𝒪 ( log L ) + 𝒪 ( log {max}_{i} dim {Π}_{i} )}{𝒪 ( log L ) + 𝒪 ( log {max}_{i} dim {Π}_{i} ) + 𝒪 ( \frac{L}{M} + log L )} \approx \frac{𝒪 ( M log L )}{𝒪 ( L )} . \qquad ( 21 )$$

Here, we are comparing the hardware cost completely from the user side: in the Q̅D̅C̅ case, without a QDC, the user may be required to implement a QRAM or a QROM. M represents a parameter related to the QRAM, QROM, or a hybrid architecture. Moreover, we assume that L is large (note that this will happen if we are assuming non-local Hamiltonians and the Hamiltonian might be dense, which is not always true in the quantum chemistry tasks). Consequently, using a QDC has a significant advantage in hardware cost from the user side. In particular, when M does not scale with L, the saving may even be exponential.

Similar advantage for a multiple user case is described in the following section. Additional potential saving of the hardware cost may come from savings in an entanglement cost of accessing an N-element data set with a QDC, which is only log N.

3.2.2 Quantum Simulation and Oracles from QDCs

A good example of running QDCs as oracle resources could be the quantum simulation algorithm, which has wide applications in quantum many-body physics, quantum field theory, and quantum computational chemistry with potential advantages compared to classical computers. Aside from the so-called Trotter simulation scheme [63-65], many quantum simulation algorithms are oracle-based, such as algorithms based on quantum walks [66, 67], multiproduct formula [68, 69], Taylor expansion [70, 71], fractional-query models [72], qubitization and quantum signal processing (QSP) [54-56]. Those oracles could naturally be implemented by the QRAM model (see, for instance, Ref. [25]).

We will give a short introduction to the qubitization and QSP algorithms here and discuss their costs. We will consider the linear combination of unitaries (LCU) decomposition as the input. We assume that the Hamiltonian is given by the following unitary strings

$$H = {\sum }_{i = 1}^{L} {α}_{i} {Π}_{i} . \qquad ( 22 )$$

For simplicity, we will assume that αᵢ>0. This is called the LCU model, and Πᵢs are usually the Pauli matrices. We introduce the ancilla states |i [symbol] : i=1, 2, . . . , L with the number of qubits log L. Furthermore, we implement the following state |G

[symbol]

$$\begin{matrix}\vert G 〉 = {\sum }_{i = 1}^{L} {g}_{i} \vert i 〉 , & {\vert {g}_{i} \vert}^{2} = \frac{{α}_{i}}{λ} , & λ = {\sum }_{i = 1}^{L} {α}_{i} ,\end{matrix} \qquad ( 23 )$$

$$and$$

$$R = 2 \vert G 〉 〈 G \vert - I , \qquad ( 24 )$$

$$U = {\sum }_{i = 1}^{L} \vert i 〉 〈 i \vert ⊗ {Π}_{i}$$

$$W = RU .$$

One could show that

$$\frac{H}{λ} = ( 〈 G \vert ⊗ I ) U ( \vert G 〉 ⊗ I ) , \qquad ( 25 )$$

$$〈 G \vert {W}^{n} \vert G 〉 = {T}_{n} ( \frac{H}{λ} ) ,$$

where Tₙ is the n^{th} Chebychev polynomial. The Hamiltonian evolution e^{-iHt} could be given by

$${e}^{- iHt} = {J}_{0} ( - λ t ) + 2 {\sum }_{n = 1}^{+ ∞} {i}^{n} {J}_{n} ( - λ t ) {T}_{n} ( \frac{H}{λ} ) . \qquad ( 26 )$$

Namely, one could separately add all terms together, and it requires

$$𝒪 ( λ t \times log \frac{1}{ϵ} ) , \qquad ( 27 )$$

number of queries to the operation U and |G [symbol] . Here, t is the Hamiltonian evolution time, and ∈ is the error. Here, implementing |G [symbol] is a quantum oracle operation, which may be operated by QRAM or QROM. For simplicity, here we mostly discuss the query complexity made by |G [symbol] , and U itself costs [symbol] (LC₁) primitive gates, where C₁ is the maximal complexity of implementing a single Pauli term Πᵢ. In terms of gate counting, G itself would cost [symbol] (L) primitive gates. A more complicated construction, which is called the quantum signal processing (QSP) [73], could reduce the above product in query complexity to addition

$$𝒪 ( λ t + log \frac{1}{ϵ} ) . \qquad ( 28 )$$

Another ingredient of our analysis would combine the quantum network. Quantum network, based on hardware realizations of quantum teleportation and quantum cryptography, is expected to be efficient for transferring quantum states and their associated quantum data across long distances with guaranteed security [10]. Specifically, here we describe the quantum repeaters, architectures that could significantly overcome the loss errors and depolarization errors for quantum communication with photons (see, for instance, Ref [12]). For cost estimation, we follow the discussion in Ref. [13]. There are three different generations of quantum repeaters, and here we will, for simplicity, discuss them together. A universal measure of cost overhead for those quantum repeaters is the cost coefficient C₂(C′ used in Ref. [12]), which could be understood as the qubit×time cost for the transmission of one Bell pair per unit length. Now, we will assume that for the quantum teleportation task of the data center, we use Lₜₒₜ length. The characteristic time is given by t_{ch} (which is different from three different generations of quantum repeaters).

For our minimal definition of the quantum data center, with QDCs serving as the remote oracle resources, one could compute the total time cost Tₜₒₜₐₗ and the qubit cost Nₜₒₜₐₗ as the following

$${T}_{total} = 𝒪 ( λ t + log \frac{1}{ϵ} ) \times ( 𝒪 ( {LC}_{1} ) + 𝒪 ( M {log}^{2} L ) + {t}_{c h} ) , \qquad ( 29 )$$

$${N}_{t o t a l} = 𝒪 ( log L ) + 𝒪 ( log {max}_{i} dim {\prod }_{i} ) + 𝒪 ( \frac{L}{M} + log L ) + 𝒪 ( log L \times \frac{{C}_{2}}{{t}_{c h}} {L}_{t o t} ) .$$

The total cost calculations above are explained with the following list:
i. The first term in the time cost,

$$𝒪 ( λ t + log \frac{1}{ϵ} ) ,$$

is exactly the query complexity of QSP. Based on our minimal definition of the quantum data center, the cost of each query, including the quantum communication cost and the QRAM/QROM cost.
ii. The term [symbol] (LC₁) in the time cost corresponds to the cost of each U in the QSP algorithm.
iii. The parameter M corresponds to the parameter of the hybrid QRAM/QROM construction [24, 25], which is a way to unify the hardware-time cost. A pure QRAM would cost [symbol] (L) qubits in [symbol] (log L) time, while QROM would cost [symbol] (log L) qubits in [symbol] (L log L) time. With the tunable parameter M, the hybrid construction would cost [symbol] (log L+L/M) qubits within [symbol] (M log L) time, which could reduce to QRAM with M=1 and QROM with M=L. This is how the

$$𝒪 ( \frac{L}{M} + log L )$$

term comes in the second term.
iv. The form of the oracle |G [symbol] is identical to the amplitude encoding oracle, which could reduce to the QRAM definition (the data-lookup oracle) with [symbol] (log L) time cost overhead (without post-selection), or [symbol] (1) time cost overhead (with post-selection) [25]. Here, for simplicity, we are using the case without post-selection. Thus, aside from the hybrid QRAM/QROM time cost [symbol] (M log L), we have an extra [symbol] (log L) factor, which gives the [symbol] (M log²L) factor in Tₜₒₜ.
v. The term

$$𝒪 ( log L \times \frac{{C}_{2}}{{t}_{c h}} {L}_{t o t} )$$

comes from the definition of C₂ in quantum repeaters, followed by the actual qubits and the corresponding maximal possible Bell pairs we are using when doing teleportation [13].

As long as we know the exact setups of QDCs, we could decide the resources easily based on our requirement as described by the general setup. Assuming a cost function F_{cost}, one could determine the set of hyperparameters both in quantum communication and quantum simulation by

$${M}^{*} , {L}_{t o t}^{*} , other hyperparameters … = arg min {F}_{c o s t} . \qquad ( 30 )$$

We mention that QDCs could potentially provide transducers to transform different types of quantum data, for instance, from digital qubits to analog qubits. Since various different forms of qubits have their own advantages and challenges, it is necessary to consider hybrid quantum systems. For example, if we wish to combine quantum computation performed in the superconducting qubit systems, and quantum communication provided by transformations of optical photons across long distances in QDC and its users, quantum transducers might be necessary. See for instance Ref. [74]. Here in this example, since the quantum simulation algorithms could be performed by superconducting qubits, while the quantum network could be realized by optical photons, the quantum transducer is needed.

Finally, we consider the case where we only count the hardware cost from users. In the case where we do not have QDCs, each user may be required to implement a QRAM or a QROM in the quantum simulation algorithm. Thus, in the case where users have access to QDCs, we could subtract the hardware contribution from QDC. We could compute the hardware cost ratio between the case where we have QDCs, and the case where we do not have QDCs (Q̅D̅C̅). The answer is

$$\frac{QD {C}_{h a r d w a r e}}{{\overline{QDC}}_{h a r d w a r e}} = \frac{𝒪 ( log L ) + 𝒪 ( log {max}_{i} dim {\prod }_{i} )}{𝒪 ( log L ) + 𝒪 ( log {max}_{i} dim {\prod }_{i} ) + 𝒪 ( \frac{L}{M} + log L )} \approx \frac{𝒪 ( M log L )}{𝒪 ( L )} . \qquad ( 31 )$$

Here, we take the large L limit. Thus the L-dependent term will be dominant. We could see that, especially when M is not scaling with L, this will be an exponential saving of the hardware cost for QDC users.

### 3.2.3 QDC for Computing: Multiple Users

In this section, we discuss a simple situation where QDC has multiple users and discuss its usage. Consider the case where multiple users want the same answer of a quantum algorithm. For simplicity, we assume the answer should be classical such that it is able to be copied to multiple users (the result may also be quantum, but approximate quantum cloning may then be used). We define the hardware cost of the quantum algorithm U for a single user as f_{U}(θ_{U}, θ_{U}) where θ₀ is the problem parameter, and θ_{U} is the hyperparameter of the algorithm. Say that we have k users, and for each user, the network cost of the hardware is f_{I}(θ_{U}, θ_{I}) where θ_{I} is the hyperparameter of the algorithm. Thus, without QDC, calculations are performed independently from each user, and the total hardware cost scales as

$$f ( {θ}_{0} , {θ}_{U} ) = k {f}_{U} ( {θ}_{0} , {θ}_{U} ) . \qquad ( 32 )$$

With the QDC, the hardware cost scales as

$$f ( {θ}_{0} , {θ}_{U} , {θ}_{I} ) = {f}_{U} ( {θ}_{0} , {θ}_{U} ) + k {f}_{I} ( {θ}_{0} , {θ}_{I} ) . \qquad ( 33 )$$

Thus, the condition of the advantage of QDC may be

$$\frac{{f}_{I} ( {θ}_{0} , {θ}_{U} )}{{f}_{U} ( {θ}_{0} , {θ}_{I} )} ≪ \frac{k - 1}{k} . \qquad ( 34 )$$

Thus, we may define the ratio

$$r = \frac{k}{k - 1} \frac{{f}_{I} ( {θ}_{0} , {θ}_{I} )}{{f}_{U} ( {θ}_{0} , {θ}_{U} )} . \qquad ( 35 )$$

The smaller r is, the more useful QDC may become. The optimal r may be given by

$${r}^{*} ( {θ}_{0} , k ) = \frac{k}{k - 1} {min}_{{θ}_{U} , {θ}_{I}} \frac{{f}_{I} ( {θ}_{0} , {θ}_{U} )}{{f}_{U} ( {θ}_{0} , {θ}_{I} )} . \qquad ( 36 )$$

The observation of comparing the communication cost and the computational cost is one of the original motivations of QDCs: using teleportation, one could save computational costs for multiple users. The r coefficient we defined here, and its possible variant, could serve as a generic measure for such observations. However, the task we described before is not using the full features of QDCs. If we teleport quantum states using the quantum network, the state itself is not copiable to multiple users (even though we may copy the state approximately, the error may be significant). One could use classical networks instead or encode the classical output to quantum repeaters and make use of quantum networks. Thus, in this case, the quantum network may not necessarily be needed. It could serve as a version of QDC where QRAM is used, but the quantum network is not (see another example where we use the quantum network but not QRAM in Section 3.4). Moreover, we expect that the above generic protocol may be improved and extended to more practical applications in the real science or business situation, and the simple analysis presented here may be a general guidance towards those applications.

### 3.2.4 Surface Code and T-gate Counting

Here, we give a brief review of the T-gate counting techniques described in Ref. [43] on surface-code quantum computation. Those techniques are based on a formalism of executions in a fault-tolerant surface-code architecture from a given quantum circuit (quantum algorithm). Estimations of hardware-time trade-off for given quantum algorithms, using this formalism, are based on the hardware and algorithm assumptions, which might be different compared to other protocols (e.g., see Ref. [75]).

The formalism is established from making assumptions about basic qubit manipulations. Simple operations such as qubit initializations and single-patch measurements may be regarded as easy, and they may cost zero time-unit. Herein, the term time-unit refers to an arbitrary cost unit and may be based on a real hardware. Operations such as two or multiple-qubit measurements and patch deformation may cost one time-unit.

The procedure of estimating the hardware-time cost for a given quantum circuit is the following. Firstly, we decompose the target unitary operation as Clifford+T-gates. Usually, we assume that the Clifford gates are cheap and T-gates are expensive. In fact, T-gates may be regarded as classical operations, but a given T-gate may require consumption of a single magic state, |0 [symbol] +e^{i#/4}|1 [symbol] . Magic state distillation described in Ref. [41] may be used to generate high-quality magic states in a large-scale quantum computation.

Further the treatment of a series of Clifford+T-gates may contain designing data blocks (blocks of tiles where the data qubits live), distillation blocks (blocks of tiles to distill magic states), and their combinations. In Ref. [43], several protocols are discussed for hardware-time costs. Finally, for a given large-scale quantum algorithm, precise designs are presented to minimize the hardware-time cost, especially the costs from T-gates and magic state distillation, and the costs may be pinned down to the number of qubits, gates, and even hours of time costs from assumptions of time-unit. In the T-gate example in Section 2 above, we point out that QDCs could serve as a T-gate factory and could reduce the T-gate counts significantly.

Based on the setup of qubit numbers and the required target failure probability, the main takeaways from this analysis are as follows. First, a 116-to-12 magic state distillation scheme is sufficient, as the probability of logical error in the distilled magic state is <10⁻¹⁰ hence the total probability that any of the 10⁸ magic states is faulty is <1%. Once the distillation scheme is chosen, the total number of surface code tiles (210) and cycles (11d×10⁸) required by the algorithm can be determined, and hence the minimum code distance can be calculated. For the above parameters, a distance d=27 is required to keep the total logical error probability below 1%. This translates into a cost of 306,000 physical qubits and a runtime of 7 hours (assuming each surface code cycle takes 1 μs). These costs constitute a baseline for our later comparisons.

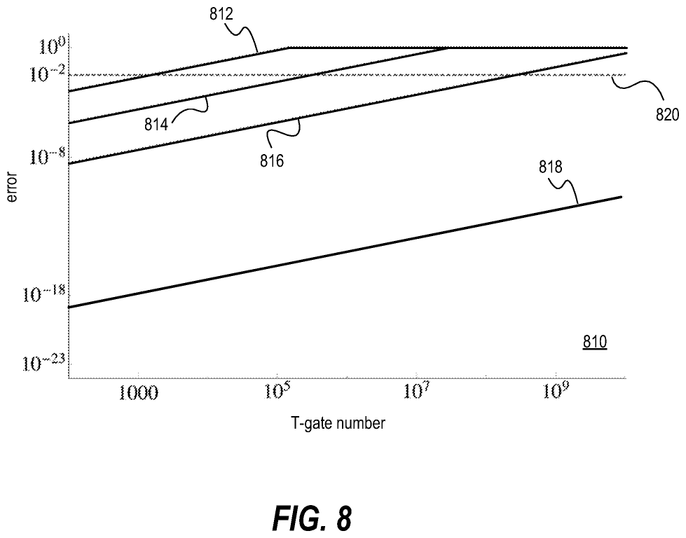

FIG. 8 is a plot 810 illustrating a dependence of the total error on the physical error rate p for different magic state distillation schemes described in Ref [43]. The plot 810 includes a trace for each scheme: 14-to-2 scheme 812, 15-to-1 scheme 814, 116-to-12 scheme 816, 225-to-1 scheme 818. The plot 810 also include a threshold line 820 at 10⁻² that indicate the maximum desired total error. The plot 810 may be used to determine the optimal magic state distillation scheme for a given number of T-gate costs. Following Ref. [43], the following formulas are used to estimate the total error for each scheme for a total error below one:

$$\begin{matrix}total error {( p )}_{14 - 2} \approx 7 {p}^{2} , \\ total error {( p )}_{15 - 1} \approx 35 {p}^{3} , \\ total error {( p )}_{116 - 12} \approx 41.25 {p}^{4} , \\ total error {( p )}_{225 - 1} \approx 35 {( 35 {p}^{3} )}^{3} .\end{matrix} \qquad ( 37 )$$

The plot 810 may be used for a proper choice of magic state distillation schemes. For example, when the number of T-gates is 10⁸, the 116-to-12 scheme 816 may be chosen for the total error to be below the threshold line 820.

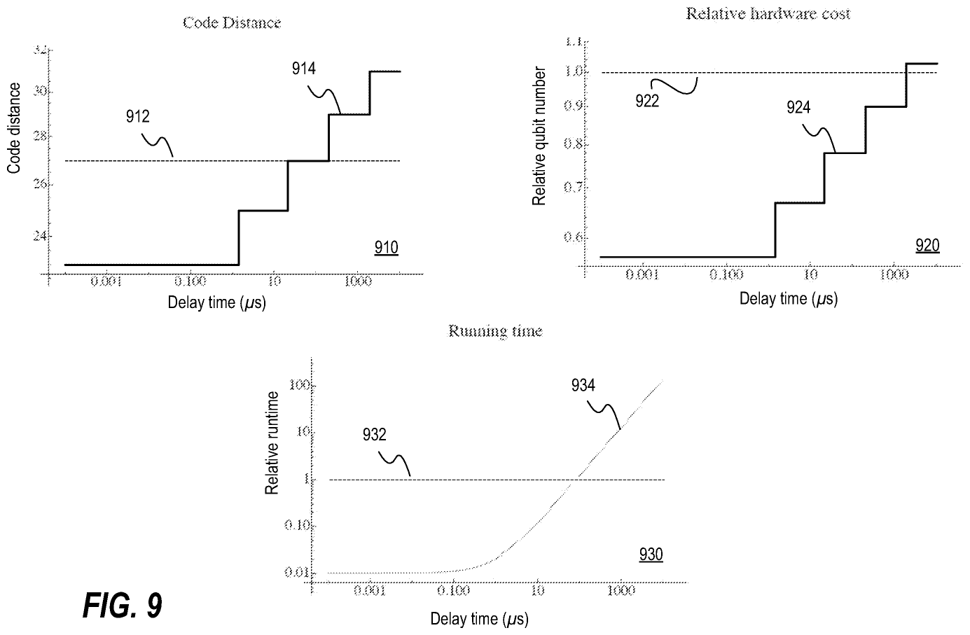

Now, in the same situation of the main text, we make an analysis on the pure hardware savings depending on the delay factor and the delay time. FIG. 9 show plots 910, 920, and 930 that illustrate the savings associated using an embodiment of the QDC 110 of FIG. 1. The plot 910 compares a QDC-assisted code distance d 914 with a non-QDC code distance d 912. The plots 920 and 930 shows relative hardware cost 924 and relative running time cost 934, respectively. Comparison lines 922 and 932 indicate where the performance between a QDC-assisted and a non-QDC architectures is the same. The relative hardware cost in plot 920 is based on the number of qubits used. The relative running time cost in plot 930 depends on a delay factor or an actual delay time and assumes 1 μs per code cycle. Since the delay factor is not related to the choice of magic state distillation schemes, in the QDC situation, the 15-to-1 scheme is used. When the delay factor is high (e.g., large waiting time from quantum communication), no significant advantage is seen from using QDC. However, when quantum communication is fast and the delay factor is small, a significant saving in hardware and time is achieved in using QDC. For example, when the delay factor ≤21 (≤1 [symbol] (10 μs) for the delay time), the code distance may be set from d=27 to d=25. When the delay factor ≤1910 (≤ [symbol] (1 ms) for the delay time), the QDC-assisted architecture may outperform a non-QDC architecture when measured in hardware overhead. When the delay factor ≤83 (≤ [symbol] (100 μs) for the delay time), the QDC-assisted architecture may outperform a non-QDC architecture when measured in time overhead.

### 3.3 Quantum Communication

In the context of quantum communication, QDCs can be used to guarantee privacy, with a variety of potential applications. The essential feature of the QDC that enables this privacy is the ability of QRAM to perform queries to data in superposition. By secretly choosing to perform classical queries or superposed queries, then examining the results, users can determine whether other parties (including the QDC) may have tampered with the queries.

This basic idea is operationalized in the quantum private queries (QPQ) protocol of Ref. [26], which we describe below. This protocol allows users to access classical data with privacy guarantees, and this same idea can be applied to enable efficient blind quantum computation [57]. Both protocols may be directly implemented using a QDC.

### 3.3.1 Quantum Private Queries

A QDC can be directly used to implement the quantum private queries protocol of Ref. [26]. In the protocol, a user Alice (e.g., user 220, FIG. 2) wants to access a classical data that is stored in a remote database (held by Bob), for example by database (Bob) 212. Alice wishes to access the data without revealing to Bob which data elements she has accessed. At the same time, Bob wants to maintain the privacy of his database, only sending Alice the information she requests.

The protocol of Ref. [26], quantum private query (QPQ), guarantees both user and database privacy by storing the data in QRAM. To access the i^{th} element of a length-N database, Alice prepares a log N-qubit register in the state |i [symbol] and transmits this state to Bob. Then, Bob uses this state as input to a QRAM query, so that the corresponding classical data, xᵢ, is encoded in an output qubit register. Both the input and output registers are then returned to Alice. As such, database privacy is guaranteed because Bob must only transmit one element of the data back to Alice. To guarantee user privacy, Alice randomly chooses to either send initial state |i [symbol] or a lure state (|i [symbol] +|0 [symbol] )/\sqrt{2} to Bob (which she chooses is unknown to him). By performing measurements on the states Bob returns, Alice may ascertain whether or not Bob has attempted to learn the value of i. Thus, Alice maintains her privacy.

The implementation of this protocol with a QDC is not hard. The QDC consists of a QRAM, so the QDC simply plays the role of Bob in the protocol. Moreover, QDC provides an application of the QPQ protocol through the quantum network.

Now we quantify the protocol more precisely. In fact, instead of considering the states |i [symbol] and (|i [symbol] +|0 [symbol] )/2, we could consider more general states [26]. Bob needs to make choices in one of the two following scenarios:

$$\begin{matrix}{{{\vert {S}_{A} 〉 = \vert j 〉}_{{Q}_{1}} ⊗ \frac{1}{\sqrt{2}} ( \vert j 〉}_{{Q}_{2}} + \vert r 〉}_{{Q}_{2}} ) , \\ {{{\vert {S}_{B} 〉 = \frac{1}{\sqrt{2}} ( \vert j 〉}_{{Q}_{1}} + \vert r 〉}_{{Q}_{1}} ) ⊗ \vert j 〉}_{{Q}_{2}} ,\end{matrix} \qquad ( 38 )$$

where S_{A,B} are made by the joint states of two queries: Q₁ and Q₂. All possible operations from Bob could be summarized by two unitaries: Uᵢ and U₂. U₁ (U₂) acts on the query space Qᵢ (Q₂), the associated register system Rᵢ (R₂), and Bob's ancillary system B (now we could understand it as Bob's QDC). If Bob is honest, the algorithm of Bob is to make use of QRAM, uploading the information from Q₂ to registers, and the states in Q₂ will not be changed. If not, Bob's remaining system Q₂ will be entangled with the rest at the end. One could compute the final state of Alice:

$${ρ}_{ℓ} ( j ) ≡ T {r}_{B} [ {U}_{2} {U}_{1} \vert {Ψ}_{ℓ} ( j ) 〉 〈 {Ψ}_{ℓ} ( j ) \vert {U}_{1}^{†} {U}_{2}^{†} ] , \qquad ( 39 )$$

where [symbol] =A, B, and

$${{\vert {Ψ}_{ℓ} ( j ) 〉 = \vert {S}_{ℓ} 〉}_{{Q}_{1} {Q}_{2}} \vert 0 〉}_{R B} . \qquad ( 40 )$$

Moreover, the final state of Q₂ is given by

$${σ}_{ℓ} ( j ) ≡ T {r}_{{Q}_{1} {Q}_{2} {R}_{1} {R}_{2}} [ {U}_{2} {U}_{1} \vert {Ψ}_{ℓ} ( j ) 〉 〈 {Ψ}_{ℓ} ( j ) \vert {U}_{1}^{†} {U}_{2}^{†} ] . \qquad ( 41 )$$

One could quantify the amount of information Bob could obtain from Alice by the mutual information I_{B}. We will use the Holevo information associated with the ensemble {pⱼ, σ(j)}, where pⱼ=1/N is the probability for choosing j, and σ(j)=[σ_{A}(j)+σ_{B}(j)]/2 is the final state of Q₂, since Alice has an equal probability to choose [symbol] =A, B. Thus, one could obtain as in Ref. [76]

$${I}_{B} \leq c {ϵ}_{p}^{1 / 4} {log}_{2} N . \qquad ( 42 )$$

Here c is a constant, c≤631, and ∈ₚ is the maximal probability where Alice finds that Bob is not cheating. Namely, if we use 1− [symbol] (j) to denote the probability where Bob passes Alice's test, then [symbol] (j)≤∈ₚ. As a summary, I is a measure of how honest Bob remains, and ∈ₚ is a result of Alice's test. The above inequality is originated from the information-disturbance trade off, and the Holevo bound [27]. The ∈ₚ^{1/4} dependence is coming from repetitively taking the square root between amplitudes and probabilities in quantum mechanics.

Now we relate ∈ₚ by the number of queries appearing in the QPQ protocol. Let us assume that Alice has Q queries independently sent to Bob. Note that for multiple queries, if there is at least one time when Alice finds that Bob is cheating, Alice will know that privacy is not guaranteed. The probability of Alice not finding Bob cheating among Q_{B} times in all Q times, is given by (1−∈ₚ)^{Q}^{_{B}}, where ∈ₚ is the maximal probability where Alice finds that Bob is cheating in a single time. When Q_{B} increases (1−∈ₚ)^{Q}^{_{B}}=a will decay from 1 to an [symbol] (1) number a where 1−a is not ignorable and we assume that Q_{B}<<1/∈ₚ. In this case, we have

$${Q}_{B} = \frac{log a}{log ( 1 - {ϵ}_{p} )} \approx \frac{log \frac{1}{a}}{{ϵ}_{p}} = 𝒪 ( \frac{1}{{ϵ}_{p}} ) . \qquad ( 43 )$$

### Now, we get

$${I}_{B} \leq 𝒪 ( {Q}_{B}^{- 1 / 4} log N ) . \qquad ( 44 )$$

Thus, we see that for larger Q_{B}, if Alice does not find Bob is cheating, then Alice may be more confident that Bob has less mutual information. One can also assume that Bob picks a cheating strategy by Q_{B}˜Q^{α}, where 0≤α≤1 will imply how many times Bob is cheating during the whole process. Then we have

$${I}_{B} \leq 𝒪 ( {Q}^{- α / 4} log N ) . \qquad ( 45 )$$

When designing a QDC associated with QPQ, we could introduce a joint cost measurement among time, space, and privacy. Similar to the previous analysis on quantum signal processing, we write down the costs for the QDC when implementing QPQ as

$${T}_{total} = 𝒪 ( QM log N ) + 𝒪 ( {Qt}_{c h} ) , \qquad ( 46 )$$

$${N}_{total} = 𝒪 ( \frac{N}{M} + log N ) + 𝒪 ( log N \times \frac{{C}_{2}}{{t}_{c h}} {L}_{t o t} ) .$$

Here, N is the number of qubits, Q is the total number of queries Alice has sent, M is the parameter in the hybrid QRAM/QROM construction, t_{ch} is the teleportation time per query, C₂ is the teleportation qubit×time cost for the transmission of one Bell pair per unit length, and Lₜₒₜ is the total length during teleportation. For the mutual information I_{B}, one could understand I_{B} as the privacy cost, by defining Pₜₒₜₐₗ as a monotonically decreasing function of I_{B}, since the smaller I_{B}, the larger privacy we are requiring. For simplicity, we could define Pₜₒₜₐₗ=1/I_{B}. It does not matter how we choose the monotonic function, since a redefinition of the function could be absorbed to the definition of the cost function F_{cost}. Moreover, one could also understand I_{B} as part of the hardware and the time cost, since we could write,

$$Q = 𝒪 ( {I}_{B}^{- 4 / α} {log}^{4 / α} N ) . \qquad ( 47 )$$

And if we demand a fixed value of I_{B}, we could adapt Q into the hardware and the time cost. The larger Q is, the higher costs are required:

$${T}_{total} = 𝒪 ( M \times {I}_{B}^{- 4} {log}^{4 / α + 1} N ) + 𝒪 ( {t}_{c h} \times {I}_{B}^{- 4} {log}^{4 / α} N ) , \qquad ( 48 )$$

$${N}_{total} = 𝒪 ( \frac{N}{M} + log N ) + 𝒪 ( log N \times \frac{{C}_{2}}{{t}_{c h}} {L}_{t o t} ) .$$

The total cost estimation of QDC associated with QPQ may be a joint measurement among Tₜₒₜₐₗ, Nₜₒₜₐₗ and Pₜₒₜₐₗ.

Note that in the main text, we discuss the combination of QPQ with the quantum secret sharing protocol. The original proposal on quantum secret sharing described in Ref. [9] is based on the entanglement property of the Greenberger-Horne-Zeilinger (GHZ) state, and it is a quantum scheme for sharing classical data since it relies on the measurement result. Moreover, in Ref. [8], a quantum scheme for sharing quantum data has been proposed, which is more suitable in our context. Ref. [8] constructs a ((k, n)) threshold scheme, where a quantum state is divided into n shares, while any k of them could completely reconstruct the state, but any k−1 of them cannot. It was shown that as long as n<2k, the construction is possible, and the explicit scheme has been constructed. In our case, a single Alice could divide the information to n QDCs. We could assume arbitrary k such that n<2k. Based on the practical purposes, a more specific setup of k may be used. A joint analysis of the multi-party quantum communication parameters may set a security standard for a given set of hardware.

There are studies on limitations and insecurity concerns in concepts that are related to QPQs. In fact, there are no-go theorems [77-79] on the imperfection of certain quantum computation and communication schemes. The QPQ protocol does not violate the no-go theorems [79] since the setup is different. And the QPQ protocol does not have a security requirement for the no-go theorem, where the user Alice cannot know the private key of QDCs, since QDCs do not have private keys. Those studies may potentially improve the capability of QDCs.

### 3.3.2 Efficient Blind Quantum Computation

A QDC can be directly used to implement the efficient blind quantum computation protocol of Ref. [57]. In blind quantum computation, a user, Alice, wants to perform a quantum computation using Bob's quantum computer without revealing to Bob what computation has been performed. Ref. [57] shows how this is possible through a simple application of the QPQ protocol. Bob holds a length-N database stored in QRAM, where each entry in the database corresponds to a different unitary operation that he can perform on his quantum computer. Alice tells him which operation to perform by sending a log N-qubit quantum state |i [symbol] , indicating that Bob should apply the i^{th} unitary operation, Uᵢ. Bob applies the operation without measuring the register (i.e., Bob applies a coherently-controlled operation U_{Bob}=Σᵢ| [symbol] [symbol] i|⊗Uᵢ) then sends the state back to Alice. To protect her privacy, Alice periodically sends lure states and measures the states returned to her. If Bob attempts to cheat, Alice will be able to detect it.

The implementation of this protocol with a QDC is simple, as we have already shown that a QDC can implement the QPQ protocol. In this case, though, the QDC also requires a universal quantum computer in order to perform the computation. Thus, the efficient blind quantum computation protocol could be understood as an extension of QPQ with extra powers in quantum computation. When estimating the computational cost for QDC, one should include the computational complexity of the quantum operation Uᵢ, while other analysis stay the same as QDC associated with QPQ.

### 3.4 Sensing

### 3.4.1 Quantum Data Compression

In this section, we describe how QRAM architectures can be used to implement the unary-to-binary compression described above, which could be used for quantum sensing. In particular, we show that the compression operation can be implemented using a modified version of the bucket-brigade QRAM architecture [17, 18].

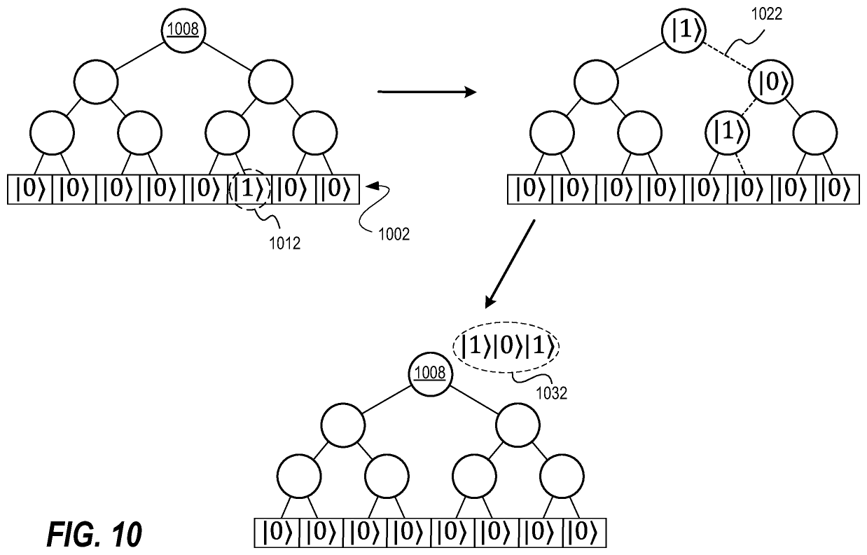

FIG. 10 illustrates an example usage of a compression scheme in a QRAM. The example includes a single excitation 1012 stored in one of N different cells 1002 in the QRAM's quantum memory (or in a superposition of multiple different cells). The compression procedure allows one to coherently extract the position of the excitation 1012 using a modified version of the bucket-brigade QRAM's binary-tree routing scheme. Specifically, the excitation is routed upward from the quantum memory at the bottom of the tree to a root node 1008 at the top. As the excitation 1012 is routed upward following a path 1022, its original position is encoded into the states of the quantum routers comprising the tree. This encoding is accomplished using a simple modification to the quantum routing circuit of Ref. [24]. Subsequently, a position information 1032 is extracted from the routers and stored in an external log N-qubit register.

The compression scheme of FIG. 10 allows a conversion of the unary information in QRAM of the photon's position into a more compact binary representation of log N qubits. The compression scheme of FIG. 10 implements a mapping of |ψ_{unary} [symbol] →|ψ_{binary} [symbol] . As a result, the state of N-mode memory (assumed to lie within the single-excitation subspace) may be compressed to log N qubits. Generalization to multi-excitation subspaces is straightforward; the procedure can be repeated to extract multiple excitations from the memory, such that the k-excitation subspace may be compressed into k log N qubits.

Additionally, the scheme in FIG. 10 may also be used to implement the operation U, which coherently extracts the address of an excitation stored in the QRAM's quantum memory. To Lo so, the first step of the compression scheme is applied,

$${{{{{{{\sum }_{i = 0}^{N - 1} {α}_{i} \vert 0 〉}^{{Q}_{1}} \vert 0 〉}^{{Q}_{2}} [ {{⊗}^{N}}_{j = 1} \vert {δ}_{ij} 〉}^{{D}_{j}} ] ⟶ {\sum }_{i = 0}^{N - 1} {α}_{i} \vert i 〉}^{{Q}_{1}} \vert 1 〉}^{{Q}_{2}} [ {{⊗}^{N}}_{j = 1} \vert 0 〉}^{{D}_{j}} ] , \qquad ( 49 )$$

where Q₁, Q₂, and Dⱼ respectively denote the external log N-qubit register, an external qubit used to hold the extracted excitation (not shown in FIG. 10), and the j^{th} cell of the quantum memory. Then, a series of CNOT gates is used to copy the address information stored in register Q₁ into another external log N-qubit register, denoted Q₁′,

$${{{{⟶ {\sum }_{i = 0}^{N - 1} {α}_{i} \vert i 〉}^{{Q}_{1}} \vert i 〉}^{{Q}_{1}^{′}} \vert 1 〉}^{{Q}_{2}} [ {{⊗}^{N}}_{j = 1} \vert 0 〉}^{{D}_{j}} ] . \qquad ( 50 )$$

Finally, the above procedure is run in reverse to return the excitation to its original location in memory

$${{{{⟶ {\sum }_{i = 0}^{N - 1} {α}_{i} \vert 0 〉}^{{Q}_{1}} \vert i 〉}^{{Q}_{1}^{′}} \vert 0 〉}^{{Q}_{2}} [ {{⊗}^{N}}_{j = 1} \vert {δ}_{ij} 〉}^{{D}_{j}} ] . \qquad ( 51 )$$

The Q₁ and Q₂ registers may subsequently be discarded.

While the above description describes unary-to-binary coding, it will be apparent to those trained in the art that the process can be reversed to perform binary-to-unary coding.

### 3.4.2 Channel Discrimination Using QDCs

In previous sections, various aspects of QDC realizations with both QRAM and quantum communications are described. However, QDCs may still be made without either QRAM or quantum communications. Here we give a simple example from quantum sensing, where QRAM is not necessarily needed.

The estimation and discrimination of quantum channels are natural problems in quantum sensing (see Refs. [80-84]). Following Ref. [84], one of the simplest problems is the following channel discrimination problem: say that we have two distributions Θ_{b} with b=0,1. For a given b, we wish to find out the value of b by accessing the quantum channel

$$\begin{matrix}{ℰ}_{b} = exp ( i {θ}_{b} H ) & {θ}_{b} ∼\end{matrix} {Θ}_{b} , \qquad ( 52 )$$

with minimal numbers of times (for the qubit setup in this paper, we could specify H as X. For higher dimensional channel discrimination, see Ref. [82]). One may define the channel discrimination protocol by the following circuits. The quantum (coherent) protocol corresponds to the following circuit

$$Q = {E}_{b , N} {\prod }_{ℓ = 1}^{N - 1} ( {V}_{ℓ} {E}_{b , ℓ} ) . \qquad ( 53 )$$

Here, N is the total number of queries, and [symbol] corresponds to [symbol] th copy of the channel ε_{b}. A series of unitaries [symbol] will define the protocol (one could specify it by QSP angles, see Ref. [84]). Say that we define the input state to be |ψᵢₙₚᵤₜ [symbol] and the output state to be |ψₒᵤₜₚᵤₜ [symbol] , the success probability is

$${p = {max}_{V , {ψ}_{input} , {ψ}_{output}} \vert 〈 {ψ}_{output} \vert Q \vert {ψ}_{input} 〉 \vert}^{2} . \qquad ( 54 )$$

For the incoherent (classical) protocol, we could perform N different measurement. Say that for [symbol] th measurement, we expect the input | [symbol] and the output | [symbol] , we will have the [symbol] th probability

$${{p}_{ℓ} = \vert 〈 {ψ}_{output , ℓ} \vert {V}_{ℓ} {E}_{b , ℓ} \vert {ψ}_{input , ℓ} 〉 \vert}^{2} , \qquad ( 55 )$$

and the protocol could be specified by the majority vote [84]. Moreover, one may specify the ξ-hybrid protocol as performing a length-ι coherent protocol N/ξ times, and the result could be determined by the majority vote of N/ξ trials. It is shown that when the channel is noiseless (Θ_{b}s are Dirac function distributions), coherent protocols always have the advantage over incoherent protocols. However, when the channel is too noisy, incoherent protocols may be better [84]. Thus, the hybrid protocols might be useful when we increase N.

If the user wants the quantum sensing to have high precision, the user may be required to go to a large N regime. In the above example, precision δ is a difference between the mean of the distributions Θ₁ and Θ₂. In the noiseless case, the optimal N scales as 1/δ[84]. Moreover, the unitaries V={ [symbol] } may be difficult to construct and design. In those cases, QDC may be useful.

The protocol with QDC may be defined as the following. On the user side, the user may generate the channel ε_{b,j}, and the user may also send the information on the distribution Θ_{b} to a QDC. The QDC may generate a series of unitaries { [symbol] } and design the optimal hybrid ξ-protocol. Each time when the state passes through the channel ε_{b,j}, the state may be teleported by the quantum network to the QDC, and the QDC applies [symbol] on the state and teleports it back. The measurement may be done either by the QDC or by the user. The majority vote may be done classically with [symbol] (N/ξ) complexity or quantumly by measuring [symbol] (N/ξ) times in the computational basis. The QDC-assisted channel discrimination protocols have advantages when it is difficult to design optimal circuits V={ [symbol] }.

### OUTLOOK AND CONCLUSION

In addition to the applications of QDC described above for computing, communication, and sensing, QDC may be used for quantum simulation, delegated blind quantum computing, multiple users, and quantum sensing with channel discrimination. Recently, we have analyzed favorable error scaling of QRAM that only scales poly-log with the size of the database [24], which implies that QDC may be an intermediate-term application without the requirement of full error correction. QDC provides an example of application-specific efficient architectural design, taking full advantage of shallow QRAM circuits and small overhead in quantum communication. Given the tree-like structure of QRAM, it will be interesting to explore the future possibility of distributed QDC, so that we may de-centralize the QRAM and perform the entire QRAM over the distributed quantum networks.

### REFERENCES

[1] R. P. Feynman, in Feynman and computation (CRC Press, 2018) pp. 133-153.
[2] P. W. Shor, SIAM Review 41, 303 (1999).
[3] L. K. Grover, Phys. Rev. Lett. 79, 325 (1997).
[4] J. Preskill, Quantum 2, 79 (2018).
[5] P. Wittek, Quantum machine learning: what quantum computing means to data mining (Academic Press, 2014).
[6] J. Biamonte, P. Wittek, N. Pancotti, P. Rebentrost, N. Wiebe, and S. Lloyd, Nature 549, 195 (2017).
[7] N. Gisin, G. Ribordy, W. Tittel, and H. Zbinden, Rev. Mod. Phys. 74, 145 (2002).
[8] R. Cleve, D. Gottesman, and H.-K. Lo, Phys. Rev. Lett. 83, 648 (1999).
[9] M. Hillery, V. Buzek, and A. Berthiaume, Phys. Rev. A 59, 1829 (1999).
[10] H. J. Kimble, Nature 453, 1023 (2008).
[11] M. Caleffi, A. S. Cacciapuoti, and G. Bianchi, in Proceedings of the 5th ACM International Conference on Nanoscale Computing and Communication (2018) pp. 1-4.
[12] S. Muralidharan, J. Kim, N. Lutkenhaus, M. D. Lukin, and L. Jiang, Phys. Rev. Lett. 112, 250501 (2014).
[13] S. Muralidharan, L. Li, J. Kim, N. Lutkenhaus, M. D. Lukin, and L. Jiang, Sci. Rep. 6, 1 (2016).
[14] C. L. Degen, F. Reinhard, and P. Cappellaro, Rev. Mod. Phys. 89, 035002 (2017).
[15] V. Giovannetti, S. Lloyd, and L. Maccone, Phys. Rev. Lett. 96, 010401 (2006).
[16] V. Giovannetti, S. Lloyd, and L. Maccone, Nat. Photon. 5, 222 (2011).
[17] V. Giovannetti, S. Lloyd, and L. Maccone, Phys. Rev. Lett. 100, 160501 (2008).
[18] V. Giovannetti, S. Lloyd, and L. Maccone, Phys. Rev. A 78, 052310 (2008).
[19] F.-Y. Hong, Y. Xiang, Z.-Y. Zhu, L.-z. Jiang, and L.-n. Wu, Phys. Rev. A 86, 010306 (2012).
[20] S. Arunachalam, V. Gheorghiu, T. Jochym-O'Connor, M. Mosca, and P. V. Srinivasan,
New J. Phys. 17, 123010 (2015).
[21] C. T. Hann, C.-L. Zou, Y. Zhang, Y. Chu, R. J. Schoelkopf, S. M. Girvin, and L. Jiang,
Phys. Rev. Lett. 123, 250501 (2019).
[22] O. Di Matteo, V. Gheorghiu, and M. Mosca, IEEE Trans. Quantum Eng. 1, 1 (2020).
[23] A. Paler, O. Oumarou, and R. Basmadjian, Phys. Rev. A 102, 032608 (2020).
[24] C. T. Hann, G. Lee, S. Girvin, and L. Jiang, Phys. Rev. X Quantum 2, 020311 (2021).
[25] C. Hann, Practicality of Quantum Random Access Memory, Ph.D. thesis, Yale University (2021).
[26] V. Giovannetti, S. Lloyd, and L. Maccone, Phys. Rev. Lett. 100, 230502 (2008).
[27] M. A. Nielsen and T. Chuang, “Quantum computation and quantum information,” (2002).
[28] R. Naik, N. Leung, S. Chakram, P. Groszkowski, Y. Lu, N. Earnest, D. McKay, J. Koch, and D. Schuster, Nat. Comm. 8, 1 (2017).
[29] N. Jiang, Y.-F. Pu, W. Chang, C. Li, S. Zhang, and L.-M. Duan, Npj Quant. In 5, 1(2019).
[30] S. Langenfeld, O. Morin, M. Korber, and G. Rempe, Npj Quant. In 6, 1 (2020).
[31] R. Babbush, C. Gidney, D. W. Berry, N. Wiebe, J. McClean, A. Paler, A. Fowler, and H. Neven, Phys. Rev. X 8, 041015 (2018).
[32] G. H. Low, V. Kliuchnikov, and L. Schaeffer, arXiv:1812.00954 (2018).
[33] D. W. Berry, C. Gidney, M. Motta, J. R. McClean, and R. Babbush, Quantum 3, 208 (2019).
[34] O. Di Matteo (2019).
[35] J. Yin, Y. Cao, Y.-H. Li, S.-K. Liao, L. Zhang, J.-G. Ren, W.-Q. Cai, W.-Y. Liu, B. Li, H. Dai, et al., Science 356, 1140 (2017).
[36] S.-K. Liao, W.-Q. Cai, W.-Y. Liu, L. Zhang, Y. Li, J.-G. Ren, J. Yin, Q. Shen, Y. Cao, Z.-P. Li, et al., Nature 549, 43 (2017).
[37] Y.-A. Chen, Q. Zhang, T.-Y. Chen, W.-Q. Cai, S.-K Liao, J. Zhang, K. Chen, J. Yin, J.-G. Ren, Z. Chen, et al., Nature 589, 214 (2021).
[38] H.-J. Briegel, W. Dur, J. I. Cirac, and P. Zoller, Phys. Rev. Lett. 81, 5932 (1998).
[39] L.-M. Duan, M. D. Lukin, J. I. Cirac, and P. Zoller, Nature 414, 413 (2001).
[40] W. J. Munro, K. Azuma, K. Tamaki, and K. Nemoto, IEEE J. Sel. Top. in Quantum Electron. 21, 78 (2015).
[41] S. Bravyi and A. Kitaev, Phys. Rev. A 71, 022316 (2005).
[42] S. Bravyi and J. Haah, Phys. Rev. A 86, 052329 (2012).
[43] D. Litinski, Quantum 3, 128 (2019).
[44] A. G. Fowler and C. Gidney, arXiv:1808.06709 (2018).
[45] J. M. Marlyn, Z. M. Rossi, A. K. Tan, and I. L. Chuang, PRX Quantum 2, 040203 (2021).
[46] There are studies about limitations and insecurity concerns about concepts that are related to QPQs. In fact, there are no-go theorems [77-79] about the imperfection of certain quantum computation and communication schemes. The QPQ protocol does not violate the no-go theorems [79] since the setup is different. In QPQ, we do not have the security requirement required for the no-theorem, where the user Alice cannot know the private key of QDCs, since QDCs do not have private keys. On the other hand, it will be interesting to understand better how those studies could potentially improve the capability of QDCs.
[47] J. M. Arrazola and V. Scarani, Phys. Rev. Lett. 117, 250503 (2016).
[48] Moreover, we remark that numerous extensions of this simple unary-to-binary compression are possible. For example, it is straightforward to generalize the above procedure to the case of multiple excitations, such that a QDC can be used to compress multi-excitation subspaces as well (see related discussions in SM about quantum data compression). QDCs could even be used for Schmacher coding [52], universal source coding [85-87], or other quantum compression tasks. The ability to efficiently compress quantum data using QRAM and related architectures is studied more thoroughly in [53].
[49] D. Gottesman, T. Jennewein, and S. Croke, Phys. Rev. Lett. 109, 070503 (2012).
[50] E. T. Khabiboulline, J. Borregaard, K. De Greve, and M. D. Lukin, Phys. Rev. Lett. 123, 070504 (2019).
[51] E. T. Khabiboulline, J. Borregaard, K. De Greve, and M. D. Lukin, Phys. Rev. A 100, 022316 (2019).
[52] B. Schumacher, Phys. Rev. A 51, 2738 (1995).
[53] C. T. Hann et al., In preparation (2022).
[54] G. H. Low and I. L. Chuang, arXiv:1610.06546 (2016).
[55] G. H. Low, T. J. Yoder, and I. L. Chuang, Phys. Rev. X 6, 041067 (2016).
[56] G. H. Low and I. L. Chuang, Phys. Rev. Lett. 118, 010501 (2017).
[57] V. Giovannetti, L. Maccone, T. Morimae, and T. G. Rudolph, Phys. Rev. Lett. 111, 230501 (2013).
[58] J. F. Fitzsimons, Npj Quantum Inf. 3, 1 (2017).
[59] J. Preskill, Nature 402, 357 (1999).
[60] D. Gottesman and I. L. Chuang, Nature 402, 390 (1999).
[61] S. Vadhan, in Tutorials on the Foundations of Cryptography (Springer, 2017) pp. 347-450.
[62] S. Lloyd, M. Mohseni, and P. Rebentrost, Nat. Phys. 10, 631 (2014).
[63] S. Lloyd, Science, 1073 (1996).
[64] M. Suzuki, Comm. Math. Phys. 51, 183 (1976).
[65] A. M. Childs, Y. Su, M. C. Tran, N. Wiebe, and S. Zhu, arXiv:1912.08854 (2019).
[66] A. M. Childs and R. Kothari, in Theory of Quantum Computation, Communication, and Cryptography, edited by W. van Dam, V. M. Kendon, and S. Severini (Springer Berlin Heidelberg, Berlin, Heidelberg, 2011) pp. 94-103.
[67] D. W. Berry, A. M. Childs, and R. Kothari, in Foundations of Computer Science (FOCS), 2015 IEEE 56^{th} Annual Symposium on (IEEE, 2015) pp. 792-809.
[68] G. H. Low, V. Kliuchnikov, and N. Wiebe, arXiv:1907.11679, (2019).
[69] A. M. Childs and N. Wiebe, Quantum Inf Comput, 12, 901 (2012).
[70] D. W. Berry and A. M. Childs, Quantum In Comput. 12, 29 (2012).
[71] D. W. Berry, A. M. Childs, R. Cleve, R. Kothari, and R. D. Somma, Phys. Rev. Lett. 114, 090502 (2015).
[72] D. W. Berry, A. M. Childs, R. Cleve, R. Kothari, and R. D. Somma, in Forum of Mathematics, Sigma, Vol. 5 (Cambridge University Press, 2017).
[73] G. H. Low and I. L. Chuang, Quantum 3, 163 (2019).
[74] M. Zhang, C.-L. Zou, and L. Jiang, Phys. Rev. Lett. 120, 020502 (2018).
[75] D. Herr, F. Nori, and S. J. Devitt, New J. Phys. 19, 013034 (2017).
[76] V. Giovannetti, S. Lloyd, and L. Maccone, IEEE Trans. Inf. Theory 56, 3465 (2010).
[77] D. Mayers, Phys. Rev. Lett. 78, 3414 (1997).
[78] H.-K. Lo and H. F. Chau, Phys. Rev. Lett. 78, 3410 (1997).
[79] H.-K. Lo, Physical Review A 56, 1154 (1997).
[80] A. Acin, Phys. Rev. Lett. 87, 177901 (2001).
[81] R. Duan, Y. Feng, and M. Ying, Phys. Rev. Lett. 98, 100503 (2007).
[82] R. Duan, Y. Feng, and M. Ying, Phys. Rev. Lett. 103, 210501 (2009).
[83] S. Zhou and L. Jiang, PRX Quantum 2, 010343 (2021).
[84] Z. M. Rossi, J. Yu, I. L. Chuang, and S. Sugiura, arXiv:2105.08707 (2021).
[85] R. Jozsa, M. Horodecki, P. Horodecki, and R. Horodecki, Phys. Rev. Lett. 81, 1714 (1998).
[86] M. Hayashi and K. Matsumoto, Phys. Rev. A 66, 022311 (2002).
[87] C. H. Bennett, A. W. Harrow, and S. Lloyd, Phys. Rev. A 73, 032336 (2006).

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated, the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A quantum data center, comprising:
a quantum computer;
a transceiver in communication with the quantum computer, the transceiver being operable to communicate with a remote user via a quantum communication network;
wherein the quantum computer is operable to:
receive, via the transceiver, a quantum input state from the remote user;
store, in a quantum random access memory, a plurality of database states in a plurality of database qudits forming a database register;
query the quantum random access memory with the quantum input state to retrieve, from the database register, a quantum output state that is based on one or more of the plurality of database states, the quantum output state being disentangled from the quantum input state and the plurality of database states; and
transmit, via the transceiver, the quantum output state to the remote user.

2. The quantum data center of claim 1, wherein:
the quantum computer includes a plurality of input qudits forming an input register and a plurality of output qudits forming an output register; and
the quantum computer is further operable to:
load the quantum input state into the input quantum register before querying the quantum random access memory; and
unload the quantum output state from the output quantum register after querying the quantum random access memory.

3. The quantum data center of claim 2, each of the plurality of input qudits and the plurality of output qudits being a qubit.

4. The quantum data center of claim 1, wherein:
the quantum computer includes a plurality of address qudits forming an address register; and
the quantum computer is further operable to store, in the address register and for each database state of the plurality of database states, a corresponding one of a plurality of address states that locate said each database state in the database register, the plurality of address states being stored in the address register as classical data.

5. The quantum data center of claim 4, wherein the quantum input state is in a superposition of at least two of the plurality of address states.

6. The quantum data center of claim 4, wherein the quantum computer is operable to store each of the plurality of address states in the address register as a product state of elements, each of the elements being in only one of a plurality of computational basis states.

7. The quantum data center of claim 4, wherein:
each of the plurality of database qudits and the plurality of address qudits is a qubit;
a number of the plurality of database states is N; and
the quantum computer is operable to store each address state using log N of the plurality of address qudits.

8. The quantum data center of claim 1, wherein the quantum computer is operable to store each of the plurality of database states in the database register as classical data.

9. The quantum data center of claim 1, wherein the quantum computer is operable to store each of the plurality of database states in the database register as quantum data.

10. The quantum data center of claim 1, wherein the quantum computer is operable to implement a fault-tolerant quantum architecture.

11. The quantum data center of claim 1, wherein the quantum computer is operable to use a Clifford+T gate set.

12. The quantum data center of claim 11, wherein the quantum computer is operable to implement a magic state distillation scheme.

13. The quantum data center of claim 1, wherein the quantum computer is operable to implement a three-state bucket-brigade quantum random access memory.

14. The quantum data center of claim 1, wherein the quantum computer is operable to implement a two-state bucket-brigade quantum random access memory.

15. A method comprising:
receiving, via the transceiver of the quantum data center of claim 1, a quantum input state from a remote user;
storing a plurality of database states in a plurality of database qudits forming a database register;
implementing, with the quantum computer of the quantum data center, a quantum random access memory with the database register;
querying, with the quantum computer, the quantum random access memory with the quantum input state to retrieve, from the database register, a quantum output state that is based one or more of the plurality of database states, the quantum output state being disentangled from the quantum input state and the plurality of database states;
transmitting, via the transceiver, the quantum output state to the remote user.

16. A method comprising:
sending, via a quantum communication network, a quantum input state to the quantum data center of claim 1; and
receiving, via the quantum communication network, a quantum output state from the quantum data center of claim 1.
